(19) United States
(12) Patent Application Publication
(10) Pub. No.: US 2026/0099827 A1
(43) Pub. Date: Apr. 9, 2026

(54) Electronic Devices and Corresponding Methods for Suggesting Potential Recipients for Notifications for Outstanding Financial Transactions

(71) Applicant: Motorola Mobility LLC, Chicago, IL (US)

(72) Inventors: Amit Kumar Agrawal, Bangalore (IN); Krishnan Raghavan, Bangalore (IN)

(21) Appl. No.: 18/911,035

(22) Filed: Oct. 9, 2024

(51) Int. Cl. G06Q 20/10

(52) U.S. Cl. CPC G06Q 20/102

(57) ABSTRACT

An electronic device and method manage financial transactions by receiving electronic payment transaction confirmations. The system determines associations between confirmations and outstanding financial transactions, extracting payment amounts and sender details. Notifications on a user interface identify these associations, facilitating efficient financial oversight. The device can handle multiple transactions, presenting reminders for overdue payments. A consolidated payment report lists outstanding debtors, enhancing financial management. The system automates the identification and notification process, supporting better decision-making in environments with numerous transactions, such as small businesses.

### BACKGROUND

### Technical Field

This disclosure relates generally to electronic devices, and more particularly to electronic devices having user interfaces.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. It would be advantageous to have improved electronic devices and corresponding methods and systems to streamline user engagement with such applications.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory electronic device being used in accordance with one or more embodiments of the electronic device.

FIG. 3 illustrates one explanatory electronic device in accordance with one or more embodiments of the disclosure presenting a screenshot in accordance with one or more embodiments of the disclosure.

FIG. 4 illustrates one explanatory electronic device in accordance with one or more embodiments of the disclosure presenting a notification in accordance with one or more embodiments of the disclosure.

FIG. 5 illustrates one explanatory method in accordance with one or more embodiments of the disclosure.

FIG. 6 illustrates one explanatory electronic device in accordance with one or more embodiments of the disclosure presenting another notification in accordance with one or more embodiments of the disclosure.

FIG. 7 illustrates one explanatory electronic device in accordance with one or more embodiments of the disclosure presenting yet another notification in accordance with one or more embodiments of the disclosure.

FIG. 8 illustrates one explanatory electronic device in accordance with one or more embodiments of the disclosure presenting still another notification in accordance with one or more embodiments of the disclosure.

FIG. 9 illustrates another explanatory method in accordance with one or more embodiments of the disclosure.

FIG. 10 illustrates still another explanatory method in accordance with one or more embodiments of the disclosure.

FIG. 11 illustrates one explanatory system in accordance with one or more embodiments of the disclosure.

FIG. 12 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, by a communication device, an electronic communication comprising an electronic payment transaction confirmation from an electronic payment transaction sender, determining, by one or more processors operable with the communication device, that the electronic payment transaction confirmation is associated with an outstanding financial transaction associated with the electronic payment transaction sender, extracting, by the one or more processors, a payment amount defined by the electronic payment transaction confirmation and the electronic payment transaction sender from the electronic payment transaction confirmation and an amount due from the outstanding financial transaction, and presenting, by the one or more processors on a user interface, a notification identifying the electronic payment transaction confirmation as being associated with the outstanding financial transaction. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to the communication device of an electronic device receiving an electronic communication defining an electronic payment transaction confirmation, associating an electronic payment transaction defined by the electronic payment transaction confirmation with an outstanding financial transaction of a plurality of outstanding financial transactions stored in a memory of the electronic device and, when a payment deadline associated with the plurality of financial transactions has passed, determining at least one other outstanding financial transaction of the plurality outstanding financial transactions is beyond the payment deadline and present, on the user interface, a reminder prompt identifying the at least one other outstanding financial transaction as described herein. The non-processor circuits may include, but are not limited to, a radio receiver, a radio transmitter, signal drivers, clock circuits, power source circuits, and user input devices.

As such, these functions may be interpreted as steps of a method to perform receiving, by a communication device, an electronic communication comprising an electronic payment transaction confirmation from an electronic payment transaction sender and determining, by one or more processors operable with the communication device, that the electronic payment transaction confirmation is associated with an outstanding financial transaction having a payment due date that is associated with the electronic payment transaction sender. The method may also determine, by the one or more processors after the payment due date is passed, at least one outstanding financial transaction debtor having an outstanding financial transaction debt associated with the outstanding financial transaction and present, by the one or more processors, a reminder prompt identifying the outstanding financial transaction debt and the at least one outstanding financial transaction debtor.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on. ” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that many businesses, one example of which might be a small tutoring business, increasingly utilize digital methods to facilitate seamless transactions with clients. Illustrating by example, a small tutoring business may use digital commerce transactions that allow students to compensate the instructor for both physical and online classes.

Embodiments of the disclosure also contemplate that these platforms enable tutors to receive payments regularly, enhancing convenience for both tutors and students. The ability to share confirmations via screenshots provides tangible proof of transactions, eliminating the need for in-person cash exchanges in physical classes and offering a secure method for online classes.

Despite these advantages, embodiments of the disclosure contemplate that challenges arise in managing confirmations through screenshots. For instance, in a tutoring business tutors may face difficulties in organizing numerous screenshots across various platforms. This can lead to potential errors such as duplicate requests for payment. The accumulation of screenshots can also consume memory and create clutter, complicating the retrieval of specific records. Moreover, accidental deletion of screenshots further exacerbates the issue, resulting in the loss of tracking information.

Advantageously, embodiments of the disclosure provide a solution to these problems. In one or more embodiments, an automated tracking system addresses these challenges by streamlining the reconciliation process and ensuring accurate financial records.

In one or more embodiments, embodiments of the disclosure address these challenges by providing an artificial intelligence (AI)-based payment status report for each service receiver account on a service provider account. The system determines the receipt of incoming text-based or visual-based communications containing financial transaction details.

In one or more embodiments, the system extracts information from payment confirmations to identify the amount paid, the specific service, and payer information. In one or more embodiments, the system correlates payer information with the service receiver, even when these are different users, such as a parent paying for a child's fees.

In one or more embodiments, user preferences on cutoff dates can be received or inferred, with a consolidated payment report being surfaced after the cutoff date. In one or more embodiments, the consolidated payment report lists users who have paid on time and those with outstanding payments. Advantageously, embodiments of the disclosure provide an automated approach that minimizes errors, maintains organized records, and enhances financial management for tutors and other business owners.

In one or more embodiments, a method implemented in an electronic device involves receiving, by a communication device, an electronic communication that includes an electronic payment transaction confirmation from an electronic payment transaction sender. The method further includes determining, by one or more processors operable with the communication device, that the electronic payment transaction confirmation is associated with an outstanding financial transaction linked to the electronic payment transaction sender.

The method also involves extracting, by the one or more processors, a payment amount defined by the electronic payment transaction confirmation and the electronic payment transaction sender from the electronic payment transaction confirmation. Additionally, the method includes extracting an amount due from the outstanding financial transaction. The method presents, by the one or more processors on a user interface, a notification identifying the electronic payment transaction confirmation as being associated with the outstanding financial transaction.

Advantageously, the method enables an electronic device to automatically identify and process electronic payment transaction confirmations, reducing the manual effort required to track outstanding financial transactions. By determining the association between a payment confirmation and an outstanding transaction, the system minimizes errors in financial record-keeping and ensures timely notifications for due payments.

Integrating the extraction of payment amounts and sender details directly from electronic communications streamlines the reconciliation process, eliminating the need for manual cross-referencing of payment data. This arrangement enhances the accuracy and efficiency of financial management for users, particularly in environments with multiple transactions, such as small tutoring businesses.

Presenting notifications on a user interface that clearly identify the association between payment confirmations and outstanding transactions provides users with immediate and actionable insights. This feature supports better financial oversight and decision-making, allowing users to address outstanding payments promptly and maintain organized financial records.

To see how embodiments of the disclosure can help a small business owner, such as a tutor, consider the following use case: imagine an art tutor named Vidhya manages a class of fifty-three students, both online and offline. Vidhya sets a monthly fee cutoff date on the sixth of the month, which she strictly follows.

Now image that during one month, Vidhya suspects that not all students have paid their fees. She reviews her received messages, which contain numerous payment confirmation screenshots. Vidhya meticulously notes the payments but encounters a problem when she realizes that a recent device cleanup inadvertently deleted some screenshots. This deletion creates gaps in her records, leaving her uncertain about which students have outstanding payments.

Vidhya faces the challenge of determining whom to remind about pending payments without causing confusion or embarrassment. The reliance on manual reconciliation through screenshots proves inefficient and risky, highlighting the need for a more robust payment tracking mechanism. This situation exemplifies the complexities and potential errors associated with manual payment tracking, emphasizing the need for an automated system to streamline the process and ensure accurate financial management.

Advantageously, embodiments of the disclosure provide a solution to Vidhya's problems. In one or more embodiments, an electronic device comprises a user interface, a communication device, and one or more processors operable with the user interface and the communication device. In one or more embodiments, the processors are configured to respond to the communication device receiving an electronic communication that defines an electronic payment transaction confirmation. In one or more embodiments, the processors associate the electronic payment transaction defined by the electronic payment transaction confirmation with an outstanding financial transaction from a plurality of outstanding financial transactions stored in the memory of the electronic device.

When a payment deadline associated with the plurality of financial transactions has passed, in one or more embodiments the processors determine that at least one other outstanding financial transaction from the plurality is beyond the payment deadline. The processors then present, on the user interface, a reminder prompt identifying the at least one other outstanding financial transaction. This configuration facilitates the management of financial transactions by providing timely notifications and reminders for outstanding payments

Thus, in one or more embodiments an electronic device is configured to determine the receipt of incoming communications containing financial transaction details. The device identifies whether the communication is text-based or visual-based, such as a screenshot, and extracts relevant information. This information includes the amount paid, the specific service associated with the payment, and the payer's details. The system correlates the payer's information with the service receiver, even when these are different users, such as a parent paying for a child's fees.

The system allows for user preferences on cutoff dates to be received or inferred from previous communications. After the cutoff date, the system generates a consolidated payment report. This report lists users who have paid on time and those with outstanding payments. The automated approach minimizes errors, maintains organized records, and enhances financial management for tutors and other business owners.

The method implemented in the electronic device involves receiving an electronic communication that includes a payment transaction confirmation. The system determines the association of the payment confirmation with an outstanding financial transaction. The processors extract the payment amount and sender details, presenting a notification on the user interface. This notification identifies the payment confirmation as being associated with the outstanding transaction, facilitating efficient financial oversight and decision-making.

When a payment deadline is missed, the processors determine which transactions are overdue and present a reminder prompt on the user interface. This arrangement ensures timely notifications for outstanding payments, enhancing the accuracy and efficiency of financial management. By automating the identification and notification process, the device minimizes errors and supports better decision-making for users, particularly in environments with numerous transactions, such as small tutoring businesses.

The integration of these components allows for a seamless user experience, where the device not only tracks payments but also facilitates communication with debtors through reminder prompts. This feature provides users with immediate insights into their financial status, enabling them to address outstanding payments promptly and maintain organized financial records.

In one or more embodiments, a method implemented in an electronic device involves receiving an electronic communication that includes an electronic payment transaction confirmation from an electronic payment transaction sender. The method further includes determining, by one or more processors operable with the communication device, that the electronic payment transaction confirmation is associated with an outstanding financial transaction having a payment due date linked to the electronic payment transaction sender.

Additionally, the method involves determining, by the one or more processors after the payment due date has passed, at least one outstanding financial transaction debtor with an outstanding financial transaction debt associated with the outstanding financial transaction. The method also includes presenting, by the one or more processors, a reminder prompt identifying the outstanding financial transaction debt and the at least one outstanding financial transaction debtor.

By presenting a reminder prompt that identifies the outstanding financial transaction debt and the debtor, the system provides users with immediate and actionable insights into their financial status. This feature supports better financial oversight and decision-making, enabling users to address outstanding payments promptly and maintain organized financial records.

The integration of this functionality into the electronic device enhances the accuracy and efficiency of financial management, particularly in environments with multiple transactions, such as small tutoring businesses. The automated identification and notification process minimizes errors and supports timely communication with debtors, improving the overall user experience. Other advantages will be described below. Still others will be obvious to those of ordinary skill in the art having the benefit of this disclosure.

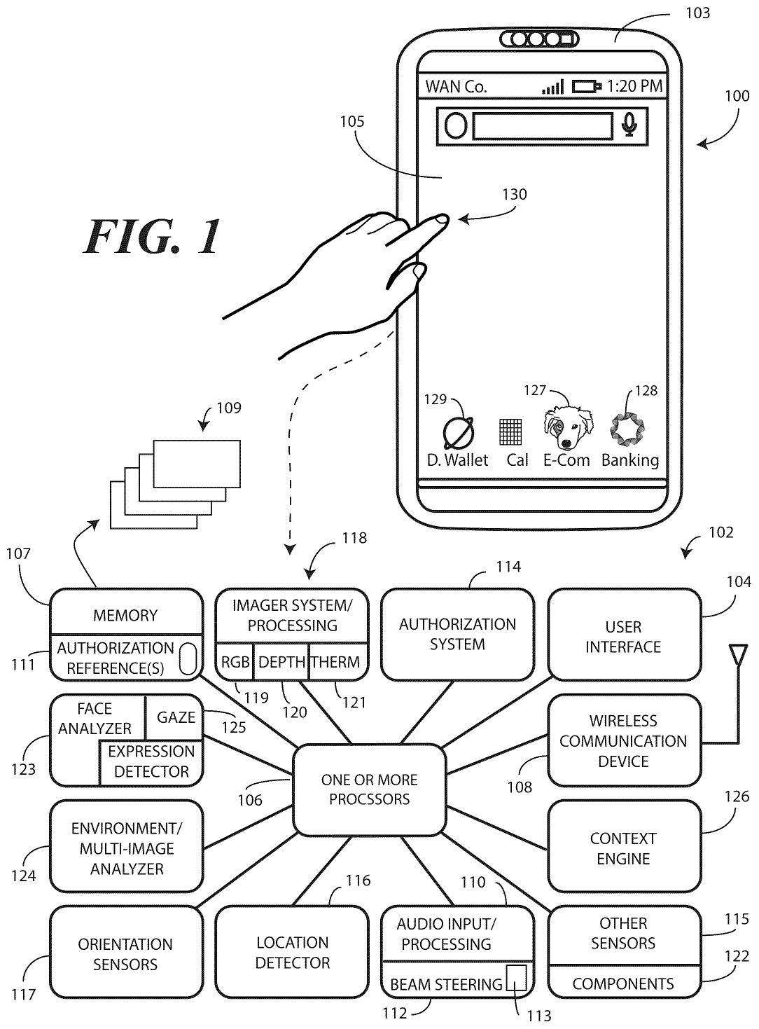

Turning now to FIG. 1, illustrated therein is one explanatory electronic device 100 in accordance with one or more embodiments of the disclosure. Also illustrated in FIG. 1 is one explanatory block diagram schematic 102 of the explanatory electronic device 100 of FIG. 1. In one or more embodiments, the block diagram schematic 102 is configured as a printed circuit board assembly disposed within a housing 103 of the electronic device 100. Various components can be electrically coupled together by conductors, or a bus disposed along one or more printed circuit boards.

The illustrative block diagram schematic 102 of FIG. 1 includes many different components. Embodiments of the disclosure contemplate that the number and arrangement of such components can change depending on the particular application. Accordingly, electronic devices configured in accordance with embodiments of the disclosure can include some components that are not shown in FIG. 1, and other components that are shown may not be needed and can therefore be omitted.

The illustrative block diagram schematic 102 includes a user interface 104. In one or more embodiments, the user interface 104 includes a display 105, which may optionally be touch-sensitive. In one embodiment, users can deliver user input to the display 105 of such an embodiment by delivering touch input from a finger, stylus, or other objects disposed proximately with the display 105. In one embodiment, the display 105 is configured as an active matrix organic light emitting diode (AMOLED) display. However, it should be noted that other types of displays, including liquid crystal displays, suitable for use with the user interface 104 would be obvious to those of ordinary skill in the art having the benefit of this disclosure.

In one embodiment, the electronic device includes one or more processors 106. In one embodiment, the one or more processors 106 can include an application processor and, optionally, one or more auxiliary processors. One or both of the application processor or the auxiliary processor(s) can include one or more processors.

One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 102. Each of the application processor and the auxiliary processor(s) can be configured to process and execute executable software code to perform the various functions of the electronic device with which the block diagram schematic 102 operates. A storage device, such as memory 107, can optionally store the executable software code used by the one or more processors 106 during operation.

In one or more embodiments, the one or more processors 106 are responsible for running the operating system environment. The operating system environment can include a kernel, one or more drivers, and an application service layer, and an application layer. The operating system environment can be configured as executable code operating on one or more processors 106 or control circuits of the electronic device 100.

The application service layer can be responsible for executing application service modules. The application service modules may support one or more applications or “apps. ” Examples of such applications include a cellular telephone application for making voice telephone calls, a web browsing application configured to allow the user to view webpages on the display 105 of the electronic device 100, an electronic mail application configured to send and receive electronic mail, a photo application configured to organize, manage, and present photographs on the display 105 of the electronic device 100, and a camera application for capturing images with the imager 119. Collectively, these applications constitute an “application suite.” In one or more embodiments, these applications comprise one or more e-commerce applications 127 and/or banking applications 128 that allow electronic commerce orders to be placed and financial transactions to be made using the electronic device 100. A digital wallet application 129 can allow users to engage in electronic payment transactions with other electronic devices, and so forth.

Illustrating by example, in one or more embodiments a user can deliver user input to an e-commerce application 127 or a banking application 128 or digital wallet application 129 to enter an electronic payment transaction request or otherwise request an electronic payment transaction occur. Thereafter, the user interface 104 can receive user input completing the electronic payment transaction to an electronic payment transaction recipient. In one or more embodiments, this results in the presentation of an electronic payment transaction confirmation by the user interface 104.

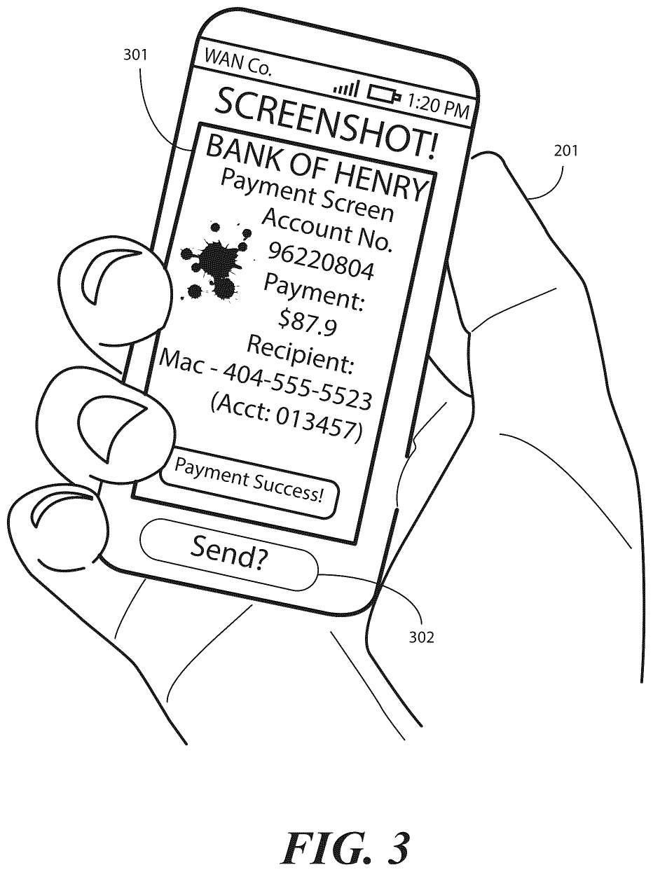

In one or more embodiments the user interface 104 can then receive other user input 130 requesting a communication device 108 of the electronic device 100 transmit a screenshot of the electronic payment transaction confirmation to a remote electronic device. Turning briefly to FIG. 3, illustrated therein is one such screenshot 301.

As shown in FIG. 3, a user 201 has delivered user input to the user interface (104) of the electronic device to cause a screenshot 301 of an electronic payment transaction confirmation. In one or more embodiments, the user interface (104) causes a user actuation target 302 to be presented as well. In one or more embodiments, actuation of the user actuation target 302 causes the screenshot 301 of the electronic payment transaction confirmation to be transmitted to another electronic device across a network.

Embodiments of the disclosure contemplate that individuals often take screenshots 301 of electronic payment transaction confirmations to provide immediate proof of payment to the recipient. This practice serves as a quick and efficient method to confirm that a transaction has been completed, especially in scenarios where the recipient requires prompt verification. By capturing the transaction details, including the amount, date, and recipient information, the sender can ensure that the recipient acknowledges the payment without delay.

Sending a screenshot 301 of the payment confirmation can also help resolve any potential disputes regarding the transaction. In cases where the recipient claims non-receipt of funds, the screenshot 301 acts as tangible evidence that the payment was initiated and processed. This can be particularly useful in informal transactions or when dealing with service providers who may not have automated systems to track payments.

Additionally, the use of screenshots 301 provides a layer of transparency and trust between the parties involved. By sharing the confirmation, the sender demonstrates a willingness to maintain open communication and accountability, fostering a positive relationship with the recipient. This method is especially beneficial in environments where immediate confirmation is necessary, such as small businesses or personal transactions

As noted above, when a person to whom many people owe money, such as a small tutoring business, receives such screenshots, they can be difficult to manage. Managing numerous screenshots 301 of electronic payment transaction confirmations can present significant challenges for individuals such as tutors with a large student base. The primary difficulty lies in organizing and sorting through a vast number of images across various communication platforms. This task becomes cumbersome and time-consuming, especially when attempting to cross-reference payments with specific students. The manual nature of this process increases the likelihood of errors, such as duplicate requests for payment or overlooking a payment entirely.

Additionally, the accumulation of screenshots 301 consumes device memory, leading to clutter and making the process difficult to locate specific payment records when needed. This clutter not only affects the device's performance but also complicates the retrieval of financial information. The risk of accidental deletion further exacerbates the issue, as losing a screenshot 301 can result in the loss of payment tracking data, disrupting financial records and potentially leading to misunderstandings with students or parents.

These challenges highlight the need for an automated system that can efficiently manage and reconcile electronic payment confirmations. Such a system would streamline the process, reduce the risk of errors, and ensure accurate and organized financial records, thereby enhancing the overall financial management for tutors and similar professionals.

Advantageously, turning now back to FIG. 1, embodiments of the disclosure provide a solution to these issues, thereby streamlining this procedure, resulting in far fewer potential errors and inefficiencies. Indeed, embodiments of the disclosure streamline the process by offering intuitive mechanisms that swiftly identify and suggest relevant wards for different types of payments that are received. Such a solution alleviates the risk of misdirected information and enhances user efficiency, ensuring screenshots are allocated to the right wards without compromising sensitive financial data. The system also records user choices for future use, further improving the accuracy and convenience of the allocation process.

In one or more embodiments, the electronic device 100 comprises a user interface, a communication device 108, and one or more processors 106 configured to manage financial transactions. In one or more embodiments, the one or more processors 106 associate an electronic payment transaction with an outstanding financial transaction stored in the device's memory 107. This configuration allows the device to automatically track and manage multiple financial transactions, reducing the manual effort required for financial oversight.

When a payment deadline is missed, the one or more processors 106 can determine which transactions are overdue and present a reminder prompt on the user interface 104. This arrangement ensures timely notifications for outstanding payments, enhancing the accuracy and efficiency of financial management. By automating the identification and notification process, the one or more processors 106 minimize errors and support better decision-making for users, particularly in environments with numerous transactions, such as small tutoring businesses.

The integration of these components allows for a seamless user experience, where the electronic device 100 not only tracks payments but also facilitates communication with debtors through reminder prompts. This feature provides users with immediate insights into their financial status, enabling them to address outstanding payments promptly and maintain organized financial records.

In one or more embodiments, the one or more processors 106 are configured to respond to the communication device 108 receiving an electronic communication that defines an electronic payment transaction confirmation. In one or more embodiments, the one or more processors 106 associate the electronic payment transaction defined by the electronic payment transaction confirmation with an outstanding financial transaction from a plurality of outstanding financial transactions stored in the memory 107 of the electronic device 100.

When a payment deadline associated with the plurality of financial transactions has passed, in one or more embodiments the one or more processors 106 determine that at least one other outstanding financial transaction from the plurality is beyond the payment deadline. The one or more processors 106 can then present, on the user interface 104, a reminder prompt identifying the at least one other outstanding financial transaction. This configuration facilitates the management of financial transactions by providing timely notifications and reminders for outstanding payments.

In one or more embodiments, the reminder prompt facilitates transmission, by the communication device 108, of at least one reminder communication that the outstanding financial transaction remains unresolved. In one or more embodiments, the reminder prompt includes at least one user actuation target allowing review of the reminder communication.

In one or more embodiments, the one or more processors 106 also present a consolidated payment report on the user interface 104 after the payment deadline has passed, listing outstanding financial transaction debtors. Additionally, the one or more processors 106 can present a notification identifying the electronic payment transaction confirmation as being associated with the outstanding financial transaction. In one or more embodiments, the notification specifies which financial transaction of multiple outstanding financial transactions the electronic payment transaction confirmation is associated with, providing clarity and aiding in financial management.

By facilitating the transmission of at least one reminder communication through the communication device 108, the electronic device 100 ensures that outstanding financial transactions are promptly addressed. This capability reduces the likelihood of missed payments and enhances the efficiency of financial management by automating the reminder process.

Incorporating a user actuation target for reviewing reminder communications allows users to verify and customize the content before sending, ensuring accuracy and relevance. This feature supports user engagement and provides control over the communication process, improving the overall user experience.

In this illustrative embodiment, the block diagram schematic 102 also includes a communication circuit 108 that can be configured for wired or wireless communication with one or more other devices or networks. The networks can include a wide area network, a local area network, and/or personal area network. The communication circuit 108 may also utilize wireless technology for communication, such as, but are not limited to, peer-to-peer or ad hoc communications such as HomeRF, Bluetooth and IEEE 802.11, and other forms of wireless communication such as infrared technology. The communication circuit 108 can include wireless communication circuitry, one of a receiver, a transmitter, or transceiver, and one or more antennas.

In one embodiment, the one or more processors 106 can be responsible for performing the primary functions of the electronic device with which the block diagram schematic 102 is operational. For example, in one embodiment the one or more processors 106 comprise one or more circuits operable with the user interface 104 to present presentation information to a user. The executable software code used by the one or more processors 106 can be configured as one or more modules 109 that are operable with the one or more processors 106. Such modules 109 can store instructions, control algorithms, and so forth.

In one or more embodiments, the block diagram schematic 102 includes an audio input/processor 110. The audio input/processor 110 is operable to receive audio input from an environment about the electronic device 100. The audio input/processor 110 can include hardware, executable code, and speech monitor executable code in one embodiment. The audio input/processor 110 can be operable with one or more predefined authentication references 111 stored in memory 107.

With reference to audio input, the predefined authentication references 111 can comprise representations of basic speech models, representations of trained speech models, or other representations of predefined audio sequences that are used by the audio input/processor 110 to receive and identify voice commands that are received with audio input captured by an audio capture device. In one embodiment, the audio input/processor 110 can include a voice recognition engine. Regardless of the specific implementation utilized in the various embodiments, the audio input/processor 110 can access various speech models stored with the predefined authentication references 111 to identify speech commands.

The audio input/processor 110 can include a beam steering engine 112 comprising one or more microphones 113. Input from the one or more microphones 113 can be processed in the beam steering engine 112 such that the one or more microphones define a virtual microphone.

This virtual microphone can define an acoustic reception cone that can be virtually “steered” around the electronic device 100. Alternatively, actual steering can occur as well, such as switching between a left and right microphone or a front and back microphone or switching various microphones ON and OFF individually. In one or more embodiments, two or more microphones 113 can be included for selective beam steering by the beam steering engine 112.

Illustrating by example, a first microphone can be located on a first side of the electronic device 100 for receiving audio input from a first direction, while a second microphone can be placed on a second side of the electronic device 100 for receiving audio input from a second direction. These microphones can be “steered”by selectively turning them ON and OFF.

The beam steering engine 112 can then select between the first microphone and the second microphone to beam steer audio reception toward an object, such as a user delivering audio input. This beam steering can be responsive to input from other sensors, such as imagers, facial depth scanners, thermal sensors, or other sensors. For example, an imager can estimate a location of a person's face and deliver signals to the beam steering engine 112 alerting it in which direction to focus the acoustic reception cone and/or steer the first microphone and the second microphone, thereby adding confirmation to audio steering and saving time. Where multiple people are around the electronic device 100, as was the case in FIG. 1, this steering advantageously directs a beam reception cone to the authorized user.

Alternatively, the beam steering engine 112 processes and combines the signals from two or more microphones to perform beam steering. The one or more microphones 113 can be used for voice commands. In response to control of the one or more microphones 113 by the beam steering engine 112, a user location direction can be determined. The beam steering engine 112 can then select between the first microphone and the second microphone to beam steer audio reception toward the user. Alternatively, the audio input/processor 110 can employ a weighted combination of the microphones to beam steer audio reception toward the user.

In one embodiment, the audio input/processor 110 is configured to implement a voice control feature that allows a user to speak a specific device command to cause the one or more processors 106 to execute a control operation. For example, the user may say, “Authenticate Me Now.” This statement comprises a device command requesting the one or more processors to cooperate with the authentication system 114 to authenticate a user. Consequently, this device command can cause the one or more processors 106 to access the authentication system 114 and begin the authentication process. In short, in one embodiment the audio input/processor 110 listens for voice commands, processes the commands and, in conjunction with the one or more processors 106, performs a touchless authentication procedure in response to voice input.

The one or more processors 106 can perform filtering operations on audio input received by the audio input/processor 110. For example, in one embodiment the one or more processors 106 can filter the audio input into authorized user generated audio input, i.e., first audio input, and other audio input, i.e., second audio input.

Various sensors 115 can be operable with the one or more processors 106. A first example of a sensor that can be included with the various sensors 115 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 106, to detect an object in close proximity with - or touching - the surface of the display 105 or the housing 103 of the electronic device 100 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor 115 is a geo-locator that serves as a location detector 116. In one embodiment, location detector 116 is able to determine location data when authenticating a user. Location can be determined by capturing the location data from a constellation of one or more earth orbiting satellites, or from a network of terrestrial base stations to determine an approximate location. The satellite positioning systems based location fixes of the location detector 116 autonomously or with assistance from terrestrial base stations, for example those associated with a cellular communication network or other ground based network, or as part of a Differential Global Positioning System (DGPS), as is well known by those having ordinary skill in the art. The location detector 116 may also be able to determine location by locating or triangulating terrestrial base stations of a traditional cellular network, or from other local area networks, such as Wi-Fi networks.

One or more motion detectors can be configured as an orientation detector 117 that determines an orientation and/or movement of the electronic device 100 in three-dimensional space. Illustrating by example, the orientation detector 117 can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The orientation detector 117 can determine the spatial orientation of an electronic device 100 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

The authentication system 114 can be operable with the one or more processors 106. A first authenticator 118 of the authentication system 114 can include an imager 119, a depth imager 120, and, optionally, a thermal sensor 121. In one embodiment, the imager 119 comprises a two-dimensional imager configured to receive at least one image of a person within an environment of the electronic device 100. In one embodiment, the imager 119 comprises a two-dimensional Red-Green-Blue (RGB) imager. In another embodiment, the imager 119 comprises an infrared imager. Other types of imagers suitable for use as the imager 119 of the authentication system will be obvious to those of ordinary skill in the art having the benefit of this disclosure.

The thermal sensor 121 can also take various forms. In one embodiment, the thermal sensor 121 is simply a proximity sensor component included with the other components 122 of the electronic device 100. In another embodiment, the thermal sensor 121 comprises a simple thermopile. In another embodiment, the thermal sensor 121 comprises an infrared imager that captures the amount of thermal energy emitted by an object. Other types of thermal sensors 121 will be obvious to those of ordinary skill in the art having the benefit of this disclosure.

The depth imager 120 can take a variety of forms. In a first embodiment, the depth imager 120 comprises a pair of imagers separated by a predetermined distance, such as three to four images. This “stereo” imager works in the same way the human eyes do in that it captures images from two different angles and reconciles the two to determine distance.

In another embodiment, the depth imager 120 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 120 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager adds a third “z-dimension” to the x-dimension and y-dimension defining the two-dimensional image captured by the imager 119, thereby enhancing the security of using a person's face as their password in the process of authentication by facial recognition.

In one or more embodiments, the authentication system 114 can be operable with a face analyzer 123 and an environmental analyzer 124. The face analyzer 123 and/or environmental analyzer 124 can be configured to process an image or depth scan of an object and determine whether the object matches predetermined criteria by comparing the image or depth scan to one or more predefined authentication references 111 stored in memory 107.

For example, the face analyzer 123 and/or environmental analyzer 124 can operate as an authentication module configured with optical and/or spatial recognition to identify objects using image recognition, character recognition, visible recognition, facial recognition, color recognition, shape recognition, and the like. Advantageously, the face analyzer 123 and/or environmental analyzer 124, operating in tandem with the authentication system 114, can be used as a facial recognition device to determine the identity of one or more persons detected about the electronic device 100.

In one embodiment when the authentication system 114 detects a person, one or both of the imager 119 and/or the depth imager 120 can capture a photograph and/or depth scan of that person. The authentication system 114 can then compare the image and/or depth scan to one or more predefined authentication references 111 stored in the memory 107. This comparison, in one or more embodiments, is used to confirm beyond a threshold authenticity probability that the person's face—both in the image and the depth scan-sufficiently matches one or more of the predefined authentication references 111 stored in the memory 107 to authenticate a person as an authorized user of the electronic device 100.

Beneficially, this optical recognition performed by the authentication system 114 operating in conjunction with the face analyzer 123 and/or environmental analyzer 124 allows access to the electronic device 100 only when one of the persons detected about the electronic device 100 are sufficiently identified as an authorized user of the electronic device 100.

Accordingly, in one or more embodiments the one or more processors 106, working with the authentication system 114 and the face analyzer 123 and/or environmental analyzer 124 can determine whether at least one image captured by the imager 119 matches a first predefined criterion, whether at least one facial depth scan captured by the depth imager 120 matches a second predefined criterion, and whether the thermal energy identified by the thermal sensor 121 matches a third predefined criterion, with the first criterion, second criterion, and third criterion being defined by the reference files and predefined temperature range.

The first criterion may be a skin color, eye color, and hair color, while the second criterion is a predefined facial shape, ear size, and nose size. The third criterion may be a temperature range of between 95 and 101 degrees Fahrenheit. In one or more embodiments, the one or more processors 106 authenticate a person as an authorized user of the electronic device 100 when the at least one image matches the first predefined criterion, the at least one facial depth scan matches the second predefined criterion, and the thermal energy matches the third predefined criterion.

In one or more embodiments, a user can “train” the electronic device 100 by storing predefined authentication references 111 in the memory 107 of the electronic device 100. These predefined authentication references 111 can be audio references, image references, depth scan references, or other types of references. Illustrating by example, the one or more processors 106 of the electronic device 100 may cause the one or more microphones 113 to capture audio samples of people situated within the environment of the electronic device 100 so that the same people can be identified at another time.

The audio input/processing module 110 can capture audio signals from the environment using one or more microphones 113. These audio signals can then be processed to extract relevant audio features. The audio input/processing module 110 can compare these extracted audio features to one or more predefined authentication references 111 stored in the memory 107. These predefined authentication references 111 may include voice samples from previous interactions, voice messages, or manually uploaded voice samples. By comparing the captured audio features to the stored references, the system can identify individuals present within the environment of the electronic device 100.

The audio input/processing module 110 can also employ a voice recognition engine to analyze the captured audio signals. This engine, where used, can extract voice recognition features and generate a voiceprint for each detected voice. The voice recognition engine can then compare these voiceprints to the predefined authentication references 111. If a match is found, the system can identify the individual associated with the voiceprint. This process allows the system to dynamically and contextually identify individuals present during a financial transaction or other events, ensuring accurate identification of participants.

In scenarios where multiple individuals are present, the audio input/processing module 110 can distinguish between different voices by analyzing voice characteristics such as pitch, tone, and speech patterns. The system can then cross-reference these characteristics with the predefined authentication references 111 to accurately identify each individual. This capability is particularly useful in environments where participants may join or leave at different times, ensuring that the system maintains an up-to-date and accurate list of individuals present.

Similarly, a user may take a series of pictures. They can include identifiers of special features such as eye color, sink color, air color, weight, and height. They can include the user standing in front of a particular wall, which is identifiable by the environmental analyzer from images captured by the imager 119. They can include the user raising a hand, touching hair, or looking in one direction, such as in a profile view. These can then be stored as predefined authentication references 111 in the memory 107 of the electronic device 100.

A gaze detector 125 can be operable with the authentication system 114 operating in conjunction with the face analyzer 123. The gaze detector 125 can comprise sensors for detecting the user's gaze point. The gaze detector 125 can optionally include sensors for detecting the alignment of a user's head in three-dimensional space. Electronic signals can then be processed for computing the direction of user's gaze in three-dimensional space.

The gaze detector 125 can further be configured to detect a gaze cone corresponding to the detected gaze direction, which is a field of view within which the user may easily see without diverting their eyes or head from the detected gaze direction. The gaze detector 125 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 125 of FIG. 1.

The face analyzer 123 can include its own image/gaze detection-processing engine as well. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 119 or the depth imager 120 for computing the direction of user's gaze in three-dimensional space.

The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

Other components 122 operable with the one or more processors 106 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 122 can also include proximity sensors. The proximity sensors fall into one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 103 of the electronic device 100. In one embodiment, the signal receiver is an infrared signal receiver to receive an infrared emission from an object such as a human being when the human is proximately located with the electronic device 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about fifteen feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 106 can cause each proximity sensor component to operate at a first “effective” sensitivity so as to receive infrared emissions from a first distance. Similarly, the one or more processors 106 can cause each proximity sensor component to operate at a second sensitivity, which is less than the first sensitivity, so as to receive infrared emissions from a second distance, which is less than the first distance. The sensitivity change can be affected by causing the one or more processors 106 to interpret readings from the proximity sensor component differently.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 122 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 122 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device.

A context engine 126 can then be operable with the various sensors to detect, infer, capture, and otherwise determine persons and actions that are occurring in an environment about the electronic device 100. For example, where included one embodiment of the context engine 126 determines assessed contexts and frameworks using adjustable algorithms of context assessment employing information, data, and events. These assessments may be learned through repetitive data analysis. Alternatively, a user may employ the user interface 104 to enter various parameters, constructs, rules, and/or paradigms that instruct or otherwise guide the context engine 126 in detecting multi-modal social cues, emotional states, moods, and other contextual information. The context engine 126 can comprise an artificial neural network or other similar technology in one or more embodiments.

In one or more embodiments, the context engine 126 is operable with the one or more processors 106. In some embodiments, the one or more processors 106 can control the context engine 126. In other embodiments, the context engine 126 can operate independently, delivering information gleaned from detecting multi-modal social cues, emotional states, moods, and other contextual information to the one or more processors 106. The context engine 126 can receive data from the various sensors. In one or more embodiments, the one or more processors 106 are configured to perform the operations of the context engine 126.

In one or more embodiments, the one or more processors 106 can be operable with the various authenticators of the authentication system 114. For example, the one or more processors 106 can be operable with a first authenticator and a second authenticator. Where more authenticators are included in the authentication system 114, the one or more processors 106 can be operable with these authenticators as well.

As will be described in more detail below, in one or more embodiments the one or more processors 106 are configured to receive, from the communication device 108, an electronic communication comprising an electronic payment transaction confirmation from an electronic payment transaction sender. One or more embodiments, the one or more processors 106 then determine that the electronic payment transaction confirmation is associated with an outstanding financial transaction associated with the electronic payment transaction sender.

In one or more embodiments the one or more processors then extract a payment amount defined by the electronic payment transaction confirmation and the electronic payment transaction sender from the electronic payment transaction confirmation and an amount due from the outstanding financial transaction. In one or more embodiments, the one or more processors 106 present a notification identifying the electronic payment transaction confirmation as being associated with the outstanding financial transaction.

In one or more embodiments, the one or more processors 106 are responsible for managing the applications and all personal information received from the user interface 104 that is to be used by the finance application 127 and/or banking application 128 after the electronic device 100 is authenticated as a secure electronic device and the user identification credentials have triggered an electronic payment transaction request. The one or more processors 106 can also be responsible for launching, monitoring, and killing the various applications and the various application service modules.

In one or more embodiments, the one or more processors 106 are operable to not only kill the applications, but also to expunge any and all personal data, data, files, settings, or other configuration tools when the electronic device 100 is reported stolen or when the finance application 127 and/or banking application 128 are used with fraudulent activity to wipe the memory 107 clean of any personal data, preferences, or settings of the person previously using the electronic device 100.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

Embodiments of the disclosure contemplate that an electronic financial transaction can be initiated for any number of a variety of reasons. Additionally, screenshots of the electronic financial transaction confirmation can be delivered to a variety of people. Moreover, the screenshot of the electronic financial transaction confirmation may be sent to recipients other than to whom the electronic financial transaction was made. Examples of each of these variations will be described in more detail with reference to the figures that follow.

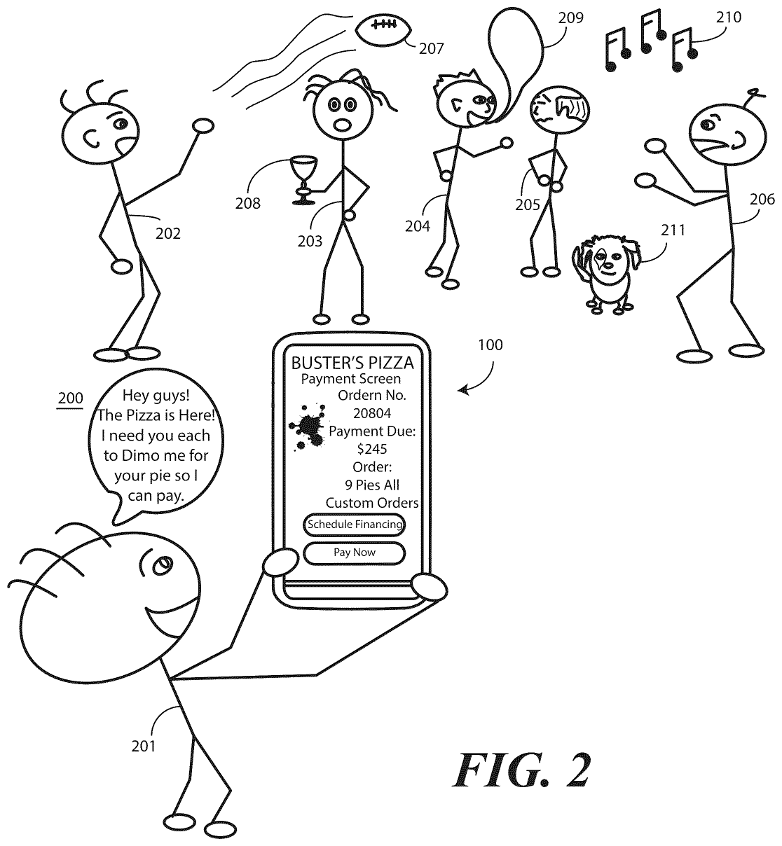

Illustrating by example, turning now to FIG. 2, illustrated therein is one explanatory system configured in accordance with one or more embodiments of the disclosure. An electronic device 100 is positioned within an environment 200. A plurality of persons 201,202,203,204,205,206 is situated within the environment 200 of the electronic device 100. Here, there are six persons 201,202,203,204,205,206 situated within the environment of the electronic device 100. Person 201, Ernest, is an authorized user of the electronic device 100.

In the illustrative embodiment of FIG. 2, persons 202,203,204,205,206 are friends, family, or acquaintances of the authorized user. Persons 202,203,204,205,206 may be authorized by the authorized user to use the electronic device 100 in one or more embodiments. In other embodiments, persons 202,203,204,205,206 may be unauthorized users of the electronic device 100.

In this illustration, used to more particularly describe various features and advantages of embodiments of the disclosure, there is a lot occurring. The scene set forth in the environment 200 of the electronic device 100 is not dissimilar to that which may occur at a family gathering, family reunion, school reunion, and so forth. In this illustration, person 202 is passing a football 207 to person 206. Person 203 is watching the action while sipping on a cocktail 208. Person 204 is having a conversation 209 with person 205. Music 210 is playing. A dog 211 is enjoying the weather and dreaming of his next meal.

Ernest has ordered pizza for the group. The pizza comes from Buster's Pizza, which is world famous for its amazing thin crust pizzas. Indeed, in the illustrative example shown in FIG. 2, the group has decided to indulge in a feast from Buster's Pizza, renowned worldwide for its exceptional quality and unique offerings. The hefty price tag of two hundred and forty-five dollars for nine pies might seem steep at first glance, but it reflects the unparalleled culinary experience that Buster's Pizza provides. Each pie is crafted with the finest ingredients, from hand-tossed dough made with imported Italian flour to the freshest, locally sourced toppings. The meticulous attention to detail and commitment to quality are what set Buster's apart from the rest.

Buster's Pizza offers a diverse menu that caters to all tastes and preferences. Their signature Truffle Mushroom Pizza, topped with a blend of wild mushrooms, truffle oil, and a sprinkle of fresh arugula, is a favorite among food critics and pizza aficionados alike. Another standout is the Margherita Supreme, which elevates the classic Margherita with heirloom tomatoes, buffalo mozzarella, and a drizzle of aged balsamic reduction. For those who enjoy a bit of spice, the Spicy Sausage and Peppers Pizza, featuring house-made sausage, roasted red peppers, and a fiery chili oil, is sure to satisfy.

The acclaim for Buster's Pizza extends far beyond its loyal customer base. Renowned food critics have lauded Buster's for its innovative approach to pizza-making and its unwavering dedication to quality. The East Broadway Times described Buster's as “a revelation in the world of pizza,” while Pizza & More Pizza magazine hailed it as “the pinnacle of pizza perfection.” These glowing reviews are a testament to the exceptional dining experience that Buster's consistently delivers.

Given the premium ingredients, artisanal craftsmanship, and critical acclaim, it's no surprise that Buster's Pizza commands a higher price. Each bite is a testament to the passion and expertise that go into every pie, making it worth every penny. So, while two hundred and forty-five dollars for nine pies might seem expensive, it's a small price to pay for a taste of what many consider to be the best pizza on the planet.

Ordinarily, splitting the bill among these persons 202,203,204,205,206, especially during this moment of joy and whimsy, would be nearly impossible. However, Ernest's electronic device 100, configured in accordance with one or more embodiments of the disclosure, can do this quickly, accurately, and automatically.

One or more processors of the electronic device 100 detect a financial transaction, which is the pizza order in this illustrative example, having a transaction amount using a digital wallet application operable on one or more processors of the electronic device 100. In one or more embodiments, the one or more processors detect a financial transaction having a transaction amount using a digital wallet application by monitoring the application for specific transaction-related events.

Illustrating by example, in one or more embodiments the user interface of the electronic device 100 receives user input completing an electronic payment transaction. As described above, in one or more embodiments this results in the presentation of an electronic payment transaction confirmation on the user interface.

In one or more embodiments, the digital wallet application, operable on the one or more processors, generates transaction events when a user initiates or completes a financial transaction. These events include data packets containing transaction details such as the transaction amount, merchant information, and timestamp. The processors can continuously, or periodically, scan the digital wallet application's event logs or transaction history to identify these transaction events.

Upon detecting a transaction event, the processors extract the relevant transaction details from the data packets. This extraction process involves parsing the data packets to retrieve the transaction amount, which is a numerical value representing the monetary value of the transaction. The processors can also identify other contextual information associated with the transaction, such as the merchant's name, location, and the time of the transaction. This contextual information helps in correlating the transaction with potential bill-splitting scenarios.

In addition to monitoring the digital wallet application's internal events, the processors may also utilize external signals to confirm the occurrence of a financial transaction. These external signals can include notifications from banking servers, confirmation messages from payment gateways, or receipts sent to the user's email or messaging applications. By cross-referencing the internal transaction events with these external signals, the processors ensure the accuracy and validity of the detected financial transaction.

Once the financial transaction is completed, Ernest is going to need to get his money from the other persons 202,203,204,205,206 situated within the environment 200. This means that persons 202,203,204,205,206 will be wards to Ernest, as a “ward,” as used herein, is one who owes a financial obligation to another.

Ernest, identified as person 201 in FIG. 2, has paid two hundred and forty-five dollars for nine pies from Buster's Pizza. To recover the shared cost from persons 202,203,204,205,206, Ernest plans to utilize his electronic device 100 to manage the transaction efficiently.

Turning now to FIG. 3, the first step involves capturing a screenshot 301 of the electronic payment transaction confirmation. This screenshot 301 serves as tangible proof of the transaction, detailing the amount paid and the merchant information.

Turning now back to FIG. 2, once the screenshot is captured Ernest intends to send the screenshot (301) to the individuals involved in the transaction, namely persons 202,203,204,205,206. By transmitting the screenshot (301), Ernest provides each person 202,203,204,205,206 with a clear record of the payment, facilitating the process of reimbursement.

The electronic device's communication capabilities allow Ernest to send the screenshot (301) directly to the recipients, ensuring that each person 202,203,204,205,206 receives the necessary information to settle their portion of the expense. This method not only streamlines the process of cost-sharing but also minimizes potential disputes by providing a transparent and verifiable record of the transaction. By leveraging the electronic device's features, Ernest can efficiently manage the financial aspect of the group purchase, ensuring that all parties are informed and accountable for their share of the payment.

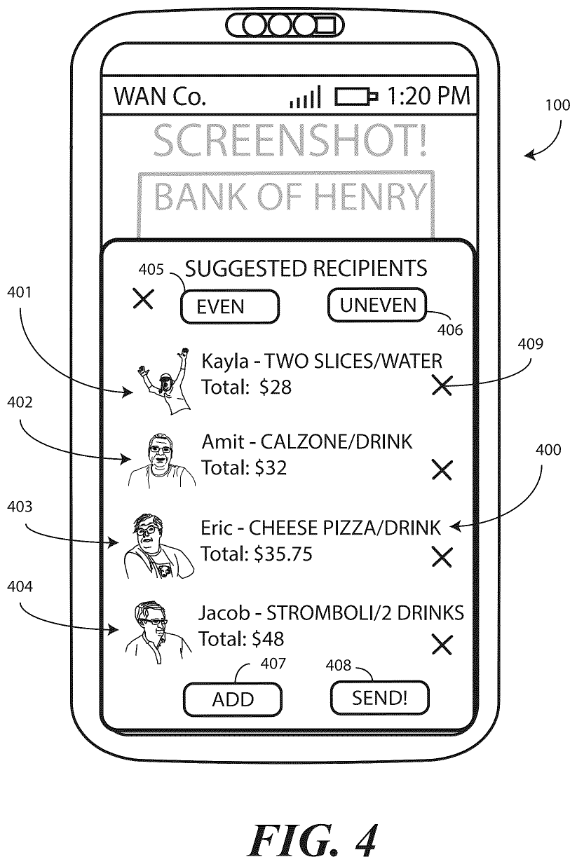

Turning now to FIG. 4, one or more processors of the electronic device 100 have detected initiation and completion of an electronic payment transaction and have identified one or more electronic payment transaction recipients of the electronic payment transaction using one or more sensors, such as image capture devices and audio capture devices, from an environment (200) of the electronic device 100. The one or more processors have also detected a screenshot capture of an electronic payment transaction confirmation presented on a user interface of the electronic device 100.

Moreover, the one or more processors have compared the one or more electronic payment transaction recipients to a contact list available to the one or more processors to obtain one or more instances of contact information corresponding to the one or more electronic payment transaction recipients. The one or more processors have further presented a prompt 400 on the electronic device 100 listing the one or more electronic payment transaction recipients.

In this illustration, since four electronic payment transaction recipients were found, the one or more electronic payment transaction recipients comprises a plurality of electronic payment transaction recipients. Accordingly, they are presented in a list.

In this illustration, the plurality of electronic payment transaction recipients is presented in a list that is prioritized by a number of prior electronic payment transaction confirmation screenshots sent to each electronic payment transaction recipient of the plurality of electronic payment transaction recipients.

In this illustrative embodiment, the prompt 400 comprises a financial transaction dividing initiation prompt, which can be actuated to identify one or more participants participating in the financial transaction identified by the user interface. In this illustrative example, the financial transaction dividing initiation prompt is presented, by the one or more processors on the user interface of the electronic device, concurrently with details of the financial transaction.

In one or more embodiments, the prompt 400 allows a user to initiate the automatic processes of capturing, with an audio input device of the electronic device, audio input from an environment about the electronic device, extracting, by the one or more processors of the electronic device, one or more audio samples identifying one or more participants situated within the environment about the electronic device and participating in the financial transaction, and automatically presenting, by the one or more processors on a user interface of the electronic device, a financial transaction dividing prompt identifying the one or more participants participating in the financial transaction and a corresponding portion of the transaction amount assigned to each participant of the one or more participants.

In one or more embodiments, the user interface presented with the financial transaction dividing initiation prompt provides a clear and concise summary of the detected financial transaction, including the transaction amount and the merchant's name. In one or more embodiments, the financial transaction dividing initiation prompt serves as an initial notification to the user that a bill-splitting scenario has been identified and requires further action. While a user can initiate the bill splitting process by actuating the financial transaction dividing initiation prompt in one or more embodiments, in other embodiments this bill splitting system will launch automatically in response to the detection of the financial transaction with the transaction amount associated therewith in the digital wallet application operating on the one or more processors of the electronic device. Whether automatic or manual via actuation of the financial transaction dividing initiation prompt can be defined in the user settings in one or more embodiments.

As shown in FIG. 4, in one or more embodiments the financial transaction dividing prompt identifies the one or more participants participating in the financial transaction. In this illustrative embodiment, the financial transaction dividing prompt also includes a corresponding portion of the transaction amount assigned to each participant of the one or more participants.

The financial transaction dividing prompt is further presented concurrently with details of the financial transaction as shown in this illustrative embodiment.

Shown at the top of the financial transaction dividing prompt are one or more user actuation targets allowing the transaction amount to be split evenly or unevenly among the one or more participants participating in the financial transaction. Illustrating by example, the financial transaction dividing prompt of FIG. 4 includes an “even” user actuation target 405 and an “uneven”user actuation target 406 situated toward the top of the prompt.

In one or more embodiments, actuating the even user actuation target 405 in the financial transaction dividing prompt will cause the transaction amount of the financial transaction to be split evenly across the participants in the financial transaction. This action ensures that each participant is assigned an equal portion of the total transaction amount, simplifying the process of bill splitting when all participants have contributed equally to, or agreed equally to divide, the shared expense. The even user actuation target 405 provides a straightforward method for dividing the bill, reducing the need for manual calculations and minimizing the potential for errors.

Conversely, actuating the uneven user actuation target 406 allows the bill to be split unevenly. This functionality is particularly useful in scenarios where participants have contributed different amounts to the shared expense.

For instance, when separate amounts are received from a merchant point of sale terminal, the uneven user actuation target 406 enables the system to allocate the correct portion of the transaction amount to each participant based on the individual amounts recorded at the point of sale. Additionally, the uneven user actuation target 406 allows for manual editing by a user, providing the flexibility to adjust the amounts assigned to each participant as needed. This feature accommodates various real-world situations where contributions may not be equal, ensuring that the bill is divided accurately and fairly among all participants.

Having both options available in the financial transaction dividing prompt enhances the versatility and usability of the system. Users can choose the even split option for simplicity and efficiency when contributions are equal or opt for the uneven split option to accurately reflect varying contributions. This dual functionality ensures that the system can handle a wide range of bill-splitting scenarios, providing users with the flexibility to manage shared expenses in a manner that suits their specific needs.

In this illustrative example, the financial transaction dividing prompt initially detected five participants, which include the user of the electronic device 100 and the four people listed in the financial transaction dividing prompt, namely Kayla 401, Amit 402, Eric 403, and Jacob 404. The detection process involved capturing audio input from the environment about the electronic device and extracting audio samples to identify the participants. The system then cross-referenced these audio samples with predefined authentication references stored in the memory of the electronic device to accurately identify each individual present during the financial transaction.

Once the participants were identified, the financial transaction dividing prompt displayed the names of the user and the four other participants. The merchant point of sale terminal transmitted a receipt of the financial transaction to a communication device of the electronic device, detailing the items each person had and their respective costs. The receipt indicated that the user had a main course and a beverage totaling $16.25. The first participant, Kayla 401, had a two slices of Buster's finest pizza and water, totaling $28.00. The second participant, Amit 402, had a calzone and a soft drink totaling $32.00. The third participant, Eric 403, had a cheese pizza and a drink, totaling $35.75. The fourth participant, Jacob 404, had a stromboli and two drinks, totaling $48.00.

The financial transaction dividing prompt automatically calculated each participant's share based on the receipt details. The user interface presented the total amount of the transaction and the individual shares assigned to each participant. The user could review the suggested shares and make any necessary adjustments before sending payment requests to the other participants. This automated process ensured accurate and efficient bill splitting, reducing the likelihood of errors and minimizing the burden on the user.

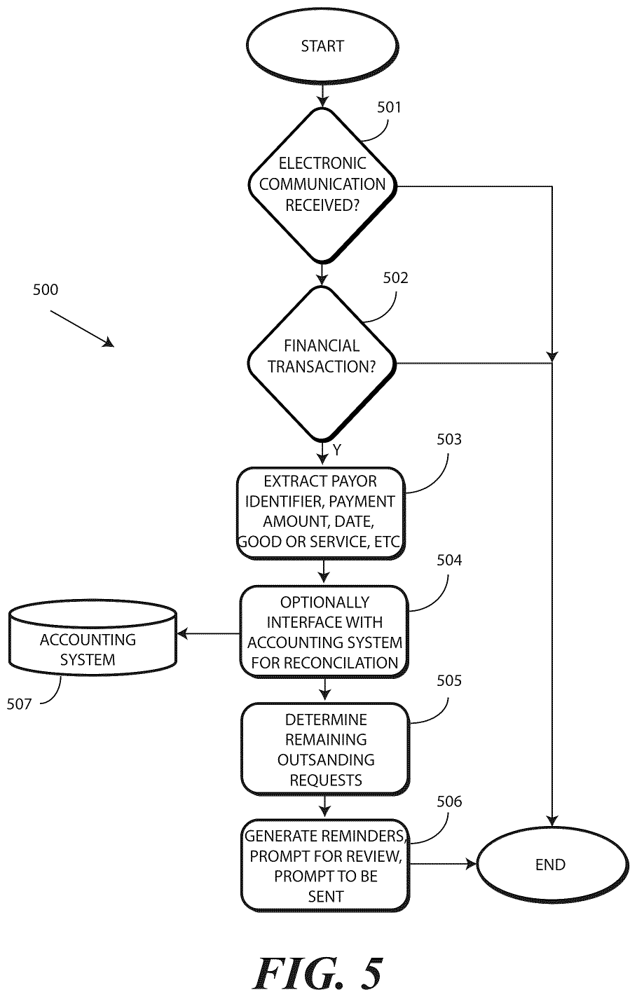

In reviewing the participants, if the user of the electronic device 100 notices that a participant has been incorrectly identified, embodiments of the disclosure allow the financial transaction dividing prompt to be edited. Illustrating by example, a deletion user actuation target 409 can allow a participant to be deleted. An addition user actuation target 407 can allow a participant to be added. A transmission user actuation target 408 allows the prompt 400 to be sent. When it it sent, the participants all become debtors to the user of the electronic device 100. Now it's time for Ernest to get paid! Turning now to FIG. 5, illustrated therein is one explanatory method 500 by which this will be accomplished.

As noted above, persons who owe money to Ernest for the meal from Buster's Pizza may utilize a digital wallet application on their electronic devices to send the owed amount. The digital wallet application facilitates the transfer of funds by allowing users to input Ernest's payment details, such as a phone number or email address linked to his digital wallet account. Once the transaction is initiated, the application processes the payment, and the funds are transferred to Ernest's account.

Upon completion of the transaction, the digital wallet application generates an electronic payment transaction confirmation. This confirmation typically includes details such as the transaction amount, date, and recipient information. Users can capture a screenshot of this confirmation (one example of which was described above with reference to FIG. 3) using their device's screenshot functionality. The screenshot serves as a visual record of the payment, providing tangible proof that the transaction has been completed.

After capturing the screenshot, users can send the screenshot to Ernest's electronic device through various communication channels, such as email, messaging applications, or social media platforms. By transmitting the screenshot, users provide Ernest with immediate verification of the payment, ensuring transparency and accountability. This process not only confirms the transaction but also helps maintain organized financial records for both parties involved.

Decision 501 of FIG. 5 involves determining whether a communication device of Ernest's electronic device receives an electronic communication, with decision 502 determining whether any received electronic communication comprises an electronic payment transaction confirmation from an electronic payment transaction sender. These decisions 501,502 can be accomplished through various techniques. One approach involves monitoring incoming communications for specific keywords or patterns that indicate a payment confirmation, such as transaction identifiers or payment amounts. Another technique employs machine learning algorithms to analyze the content of communications and identify those related to financial transactions. Additionally, integration with payment platforms or application interfaces can provide direct notifications of transaction confirmations, ensuring accurate detection.

Upon decision 501 and decision 502 determining an electronic communication that meets the criteria for a payment transaction confirmation is received, the method 500 proceeds to step 503. In one or more embodiments, this step 503 involves further processing of the transaction details to update financial records or trigger subsequent actions. If no such communication is received, the method 500 concludes, indicating that no transaction confirmation was detected. This structured approach ensures that only verified transaction confirmations are processed, maintaining the integrity and accuracy of financial management within the system.

In one or more embodiments, step 503 involves the extraction of a payment amount from an electronic payment transaction confirmation by one or more processors. This process can be accomplished through several methods, each offering distinct advantages. One approach utilizes Optical Character Recognition (OCR) technology to scan and interpret text within the transaction confirmation. This method allows for the accurate identification of numerical values representing the payment amount, ensuring precision in data extraction. OCR technology can handle various formats and fonts, making OCR technology versatile for different types of transaction confirmations.

Another method involves parsing structured data formats such as JSON or XML, which may be embedded within the transaction confirmation. This approach leverages predefined data structures to directly access the payment amount, providing a reliable and efficient means of extraction. By utilizing structured data, the system can quickly locate and retrieve the necessary information without the need for complex text analysis.

Machine learning algorithms offer an additional option by analyzing patterns and context within the transaction confirmation to identify the payment amount. This method adapts to variations in transaction formats and can improve accuracy over time through continuous learning. Machine learning provides flexibility and robustness, particularly in environments with diverse transaction confirmation styles.

In one or more embodiments, step 504 involves determining, by one or more processors operable with the communication device, that the electronic payment transaction confirmation is associated with an outstanding financial transaction linked to the electronic payment transaction sender. This determination can be accomplished through various techniques. One approach involves cross-referencing the transaction confirmation details with a database of outstanding financial transactions stored in the device's memory. The processors can match the sender's information, transaction amount, and date with records in the database to identify any corresponding outstanding transactions. This method ensures accuracy by directly comparing transaction data with existing records.

Another technique employs machine learning algorithms to analyze patterns and context within the transaction confirmation. These algorithms can identify associations between the transaction confirmation and outstanding financial transactions by recognizing recurring payment patterns or sender behaviors. This approach adapts to variations in transaction formats and can improve accuracy over time through continuous learning. Machine learning provides flexibility and robustness, particularly in environments with diverse transaction confirmation styles.

Additionally, the system can utilize natural language processing (NLP) to interpret text-based transaction confirmations. By extracting information such as sender details, transaction amounts, and dates, NLP can facilitate the association of transaction confirmations with outstanding financial transactions. This method is particularly useful for processing unstructured data, such as email confirmations or messages, where transaction details may not follow a standardized format.

In one or more embodiments, step 504 can optionally comprise interfacing, with the one or more processors, an accounting database 507 and recording the electronic payment transaction defined by the electronic payment transaction confirmation against the outstanding financial transaction. This interfacing allows for seamless integration between the electronic device and various accounting systems, ensuring accurate and up-to-date financial records. The interfacing process involves establishing a connection between the electronic device's processors and the accounting database 507, enabling the automatic transfer of transaction data. This integration facilitates the reconciliation of payments, reducing manual effort and minimizing errors in financial record-keeping.

Examples of accounting systems with which the interfacing may occur at step 504 include widely used platforms such as QuickBooks.sup.™, Xero.sup.™, and SAP.sup.™ Others will be obvious to those of ordinary skill in the art having the benefit of this disclosure. By interfacing with these accounting systems, step 504 can enhance the accuracy and efficiency of financial management, providing users with a streamlined approach to tracking and reconciling payments. This integration supports better financial oversight and decision-making, allowing users to maintain organized and comprehensive financial records.

In one or more embodiments, step 504 involves extracting an amount due from the outstanding financial transaction in addition to extracting a payment amount defined by the electronic payment transaction confirmation and the electronic payment transaction sender. The process begins with the one or more processors analyzing the electronic payment transaction confirmation to identify details such as the payment amount and sender information. This extraction utilizes techniques like Optical Character Recognition (OCR) for text interpretation or parsing structured data formats such as JSON or XML, ensuring precise identification of numerical values and relevant transaction details.

Once the payment amount and sender details are extracted, the processors cross-reference this information with a database of outstanding financial transactions stored in the device's memory. This cross-referencing allows the system to identify any corresponding outstanding transactions by matching the sender's information, transaction amount, and date with existing records. The system may also employ machine learning algorithms to recognize patterns and context within the transaction confirmation, enhancing the accuracy of the association process.

After determining the association between the payment confirmation and the outstanding financial transaction, step 504 can comprise one or more processors of the electronic device presenting a notification on the user interface. In one or more embodiments, this notification identifies the electronic payment transaction confirmation as being linked to the outstanding financial transaction, providing users with immediate and actionable insights. By presenting this information, the system facilitates efficient financial oversight and decision-making, allowing users to address outstanding payments promptly and maintain organized financial records.

In one or more embodiments step 505 involves determining, by one or more processors, at least one other outstanding financial transaction from a plurality of outstanding financial transactions that has surpassed a designated payment due date. This step 504 can utilize the system to access stored data related to multiple financial transactions, each with the associated payment deadlines. The processors analyze the transaction records to identify any financial obligations that remain unresolved past their respective due dates.

In one or more embodiments, step 505 employs algorithms to cross-reference the current date with the stored payment due dates for each transaction. By comparing these dates, the processors can ascertain which transactions are overdue. This determination is necessary for maintaining accurate financial records and ensuring timely follow-up actions, such as generating reminders or notifications for outstanding payments.

Once the system identifies overdue transactions, the system can trigger subsequent processes, such as presenting reminders on a user interface or interfacing with an accounting database to update financial records. Illustrating by example, in one or more embodiments step 506 involves generating, by the one or more processors, at least one reminder communication indicating that an outstanding financial transaction remains unresolved. In one or more embodiments, step 506 utilizes one or more processors to analyze the stored data related to financial transactions, identifying those that have surpassed their designated payment due dates. Upon determining the overdue status, the processors initiate the creation of reminder communications to notify relevant parties of the outstanding obligations.

In one or more embodiments, the reminder communication includes details such as the transaction amount, the due date, and the recipient's information. The processors can ensure that the communication is clear and concise, providing the necessary information to prompt timely action from the recipient. This process aids in maintaining accurate financial records and encourages prompt resolution of outstanding transactions.

By automating the generation of reminder communications, the system reduces the manual effort required to track and follow up on overdue payments. This automation enhances the efficiency of financial management, ensuring that users receive timely notifications and can address outstanding financial obligations promptly.

In one or more embodiments, step 506 involves presenting, by the one or more processors, a reminder prompt that identifies at least one other outstanding financial transaction. In one or more embodiments, this prompt facilitates the transmission, by the communication device, of at least one reminder communication. In one or more embodiments, the reminder prompt serves as an interface element that alerts the user to unresolved financial obligations, ensuring timely follow-up actions. The prompt can include details such as the transaction amount, due date, and recipient information, providing a clear and concise summary of the outstanding transaction.

In one or more embodiments, the system generates the reminder communication automatically, reducing the manual effort required to track and address overdue payments. By presenting the reminder prompt on the user interface, the system enables users to review and confirm the details before sending the communication. This process enhances the accuracy and efficiency of financial management, ensuring that users receive timely notifications and can address outstanding financial obligations promptly.

The reminder prompt may include user actuation targets that allow for customization of the reminder communication. Users can review the content, make necessary adjustments, and approve the transmission to the relevant parties. This feature supports user engagement and provides control over the communication process, improving the overall user experience and ensuring that financial records remain organized and up to date. In one or more embodiments. the presenting the reminder prompt occurs only when user settings of the electronic device opt in to an automatic reminder prompt presentation feature of an application operating on the one or more processors.

Now that the general method 500 of FIG. 5 has been described, attention will be turned to several use cases to further demonstrate how embodiments of the disclosure can be implemented in practice. Recall from the illustrative example described above with reference to FIGS. 2-4, our friend Ernest purchased a large bounty of food from the world famous Buster's Pizza. Moreover, his electronic device sensed the surroundings to determine who might be included in that feast, and automatically generated electronic payment transaction reimbursement requests (FIG. 4) after completing the electronic financial transaction of paying Buster's (FIG. 3). Accordingly, there now exist a plurality of outstanding financial transactions that exist, namely, a portion of the bill owed by Kayla, Amit, Eric, and Jacob.

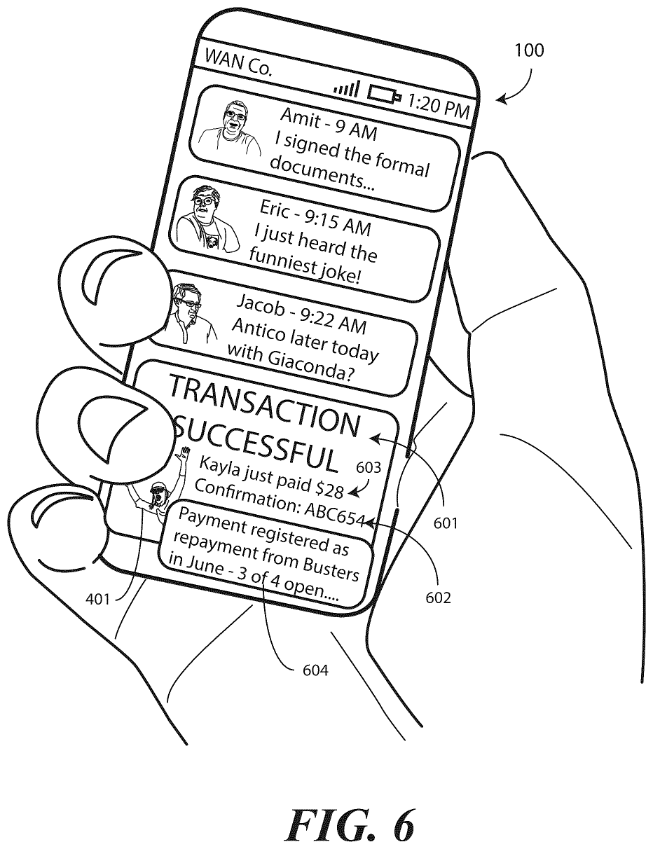

Turning now to FIG. 6, in this illustration Kayla 401 has just sent Ernest an electronic communication 601 comprising an electronic payment transaction confirmation 602. Accordingly, Kayla 401 is an electronic payment transaction sender who has used her electronic device to transmit the electronic communication 601 comprising the electronic payment transaction confirmation 602.

As described above with reference to FIG. 5, in one or more embodiments one or more processors (106) of the electronic device 100 determine that the electronic payment transaction confirmation 602 is associated with an outstanding financial transaction associated with Kayla 401 as the electronic payment transaction sender. The one or more processors (106) have extracted a payment amount 603 defined by the electronic payment transaction confirmation 602 and the electronic payment sender from the electronic payment transaction confirmation 602. By matching this payment amount 603 with the amount due (shown in FIG. 4 above) from the outstanding financial transaction, the one or more processors (106) have presented, on the user interface (104) of the electronic device 100, a notification 604 identifying the electronic payment transaction confirmation as being associated with the outstanding financial transaction.

In this illustrative example, the plurality of outstanding financial transactions are associated with a single financial transaction event, namely, the mighty feast Ernest purchased for the group from Buster's Pizza. Since Kayla 401 is the first to pay, in one or more embodiments the notification 604 can provide indicia regarding which other outstanding financial transactions remain. Illustrating by example, in the illustrative embodiment of FIG. 6, the notification 604 indicates not only the single financial transaction event, namely, Buster's, but also the number of outstanding financial transactions remaining, which are three of four in FIG. 6.

Thus, as shown in FIG. 6, the electronic device 100 operates as the central component within the system, facilitating the receipt and processing of electronic communications 601. The electronic device 100 comprises a user interface (104), a communication device (108), and one or more processors (106). The communication device (108) within the electronic device 100 receives electronic communications 601, including electronic payment transaction confirmations 602 from electronic payment transaction senders, one example of which is Kayla 401. The one or more processors (106) operable with the communication device (108) determine that the electronic payment transaction confirmation 602 is associated with an outstanding financial transaction linked to the electronic payment transaction sender. The one or more processors (106) extract a payment amount 603 defined by the electronic payment transaction confirmation 602 and the electronic payment transaction sender from the electronic payment transaction confirmation 602 and an amount due from the outstanding financial transaction. The one or more processors (106) present a notification 604 on the user interface (104), identifying the electronic payment transaction confirmation 602 as being associated with the outstanding financial transaction.

The notification 604 serves as a visual alert presented on the user interface (104) of the electronic device 100. The notification 604 identifies the electronic payment transaction confirmation 602 as being associated with the outstanding financial transaction. This notification 604 provides users with immediate and actionable insights into their financial status, facilitating efficient financial oversight and decision-making. The notification 604 ensures that users are promptly informed of the association between the payment confirmation and the outstanding transaction, allowing them to address outstanding payments and maintain organized financial records.

The electronic payment transaction confirmation 602 contains details such as the payment amount 603, date, and sender information in one or more embodiments. The one or more processors (106) can extract this information from the electronic payment transaction confirmation 602 to determine the association with an outstanding financial transaction. By accurately identifying and processing the transaction confirmation 602, the system ensures that financial records are updated and that users receive timely notifications regarding their financial obligations.

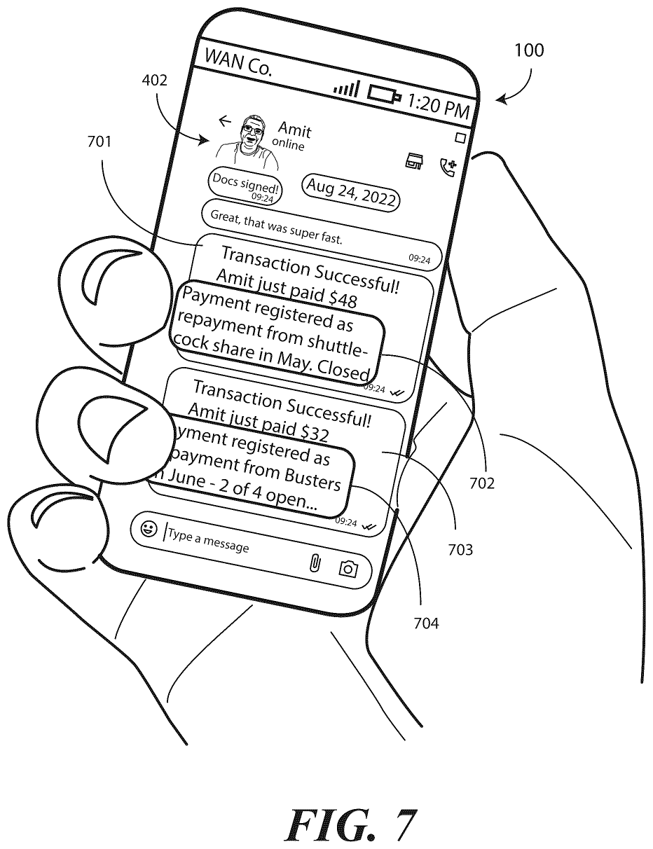

Turning now to FIG. 7, in one or more embodiments the one or more processors (106) of the electronic device 100 can also distinguish between multiple outstanding financial transaction obligations. In the illustrative example of FIG. 6, multiple debtors owed money for a single financial transaction event, which was the feast from Buster's. In FIG. 7, Amit owes not only for his share of Buster's feast, but also for new shuttlecocks for the weekend badminton marathon.

It is well known that Amit 402 is a dedicated badminton enthusiast and consistently engages in the sport, both as a spectator and an active participant. His commitment to the game extends to watching matches on television and practicing whenever possible. Amit 402 often plays during quiet Saturday mornings while the children are asleep, allowing him to focus on refining his skills. His proficiency in badminton has reached a level where his powerful smash shots frequently damage shuttlecocks, necessitating regular replacements.

Due to the impact of Amit's smash shots, his badminton league frequently requires new shuttlecock supplies. The league has recognized Amit's significant contribution to the wear and tear of the equipment and, as a result, requests that he cover a substantial portion of the costs for new shuttlecocks. This arrangement reflects both Amit's skill level and the league's need to maintain adequate equipment for continued play.

As shown in FIG. 7, Amit has forwarded two screenshots of electronic financial transaction confirmations to the electronic device 100. In one or more embodiments, the one or more processors (106) of the electronic device 100 can extract information from screenshots of electronic financial transactions to distinguish between different transactions. This has occurred in FIG. 7.

In one or more embodiments, this process involves analyzing the content of each screenshot to identify transaction details such as transaction identifier, date, amount, and payer information. Optical Character Recognition (OCR) technology can be employed to convert text within the screenshots into machine-readable data, allowing the processors to parse and categorize the information accurately.

Once the OCR technology extracts the relevant data, the one or more processors (106) can utilize pattern recognition algorithms to match the extracted details with existing records of outstanding financial transactions stored in the device's memory (107). This matching process can involve comparing transaction identifiers, amounts, and dates to ensure that each screenshot corresponds to a specific outstanding transaction. By doing so, the system can associate one screenshot with one outstanding financial transaction and another screenshot with a different transaction, maintaining the integrity of financial records.

Additionally, machine learning algorithms can enhance the accuracy of this process by learning from previous transactions and improving the system's ability to recognize and categorize transaction details. This approach allows the system to adapt to variations in screenshot formats and transaction types, ensuring that financial records remain organized and up to date. By employing these methods, the electronic device 100 can efficiently manage multiple debts, providing users with clear and accurate financial oversight.

Since two payments have been made in FIG. 7, the one or more processors (106) present, on the user interface (104), a first notification 701 identifying the electronic payment transaction confirmation as being associated with the outstanding financial transaction 702. Additionally, the one or more processors (106) present a second notification 703 identifying the electronic payment transaction confirmation as being associated with the outstanding financial transaction 704. Accordingly, as shown in FIG. 7, in one or more embodiments the user interface (104) presents two electronic payment transaction confirmations from the electronic payment transaction sender while the one or more processors cause the user interface to present two notifications 701,703 identifying the two electronic payment transaction confirmations as being associated with two different outstanding financial transactions 702,704.

Thus, as shown, the system automatically associates received electronic communications containing electronic financial transaction confirmations with the correct outstanding financial transactions. This automation eliminates the need for users to manually sort through transactions and match screenshots by hand. For a proprietor of a student tutoring business, this feature would allow for streamlined financial management, reducing errors and saving significant time. The proprietor can focus on enhancing educational offerings or expanding the business rather than dealing with tedious administrative tasks.

With the time saved, the proprietor may choose to engage in activities that enhance personal well-being or business growth. For instance, the proprietor could invest time in professional development, attend workshops, or explore new teaching methodologies. Alternatively, the proprietor might enjoy leisure activities such as pursuing a hobby, spending time with family, or simply relaxing. This newfound efficiency allows for a more balanced lifestyle, contributing to both personal satisfaction and business success.

In one or more embodiments, the one or more processors (106) of the electronic device 100 are further configured to determine at least one other outstanding financial transaction from a plurality of financial transactions is beyond a payment due date for the at least one other financial transaction. Illustrating by example, when entering outstanding financial transactions, or when they are automatically generated as was the case in FIG. 4 above, a user may define a payment due date by delivering user input to the user interface (104). Said differently, in one or more embodiments the payment due date is defined by user input received by the user interface (104) for the at least one other outstanding financial transaction.

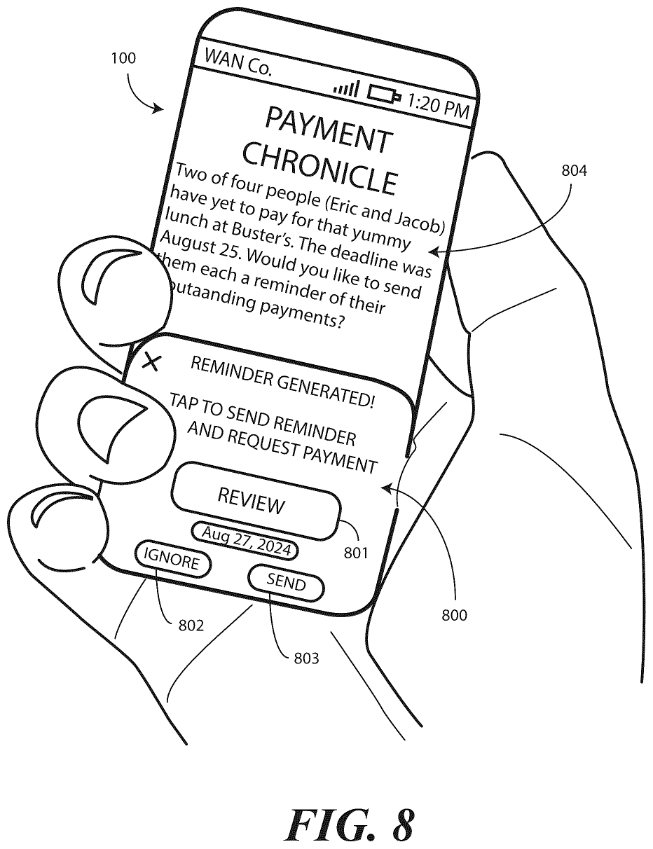

In one or more embodiments, when past due debts are found, the one or more processors (106) generate at least one reminder communication that the at least one outstanding financial transaction remains outstanding. Turning now to FIG. 8, illustrated therein is one step in generating such a reminder communication.

As shown in FIG. 8, the one or more processors (106) of the electronic device 100 have presented a reminder prompt 800 identifying that at least one other outstanding financial transaction is still outstanding. In this illustrative embodiment, the reminder prompt 800 includes a send user actuation target 803 that facilitates transmission of the reminder communication. In one or more embodiments, presentation of this reminder prompt 800 occurs only when user settings of the electronic device 100 opt in to an automatic reminder prompt presentation feature of an application operating on the one or more processors (106).

In this illustrative embodiment, the reminder prompt 800 comprises at least one user actuation target 801 allowing the at least one reminder communication to be reviewed. Additionally, the reminder prompt 800 comprises at least one send user actuation target 803 that, when actuated, causes the communication device (108) to send the at least one reminder communication. Should the user of the electronic device 100 not wish to send the reminder communication, an ignore user actuation target 802 can be actuated.

Thus, in one or more embodiments the electronic device 100 comprises a user interface (104), a communication device (108), and one or more processors (106) operable with the user interface (104) and the communication device (108). The one or more processors (106) respond to the communication device (108) receiving an electronic communication defining an electronic payment transaction confirmation. The one or more processors (106) associate the electronic payment transaction defined by the electronic payment transaction confirmation with an outstanding financial transaction from a plurality of outstanding financial transactions stored in the memory (107) of the electronic device 100. When a payment deadline associated with the plurality of financial transactions has passed, the one or more processors (106) determine that at least one other outstanding financial transaction from the plurality is beyond the payment deadline. The one or more processors (106) then present, on the user interface (104), a reminder prompt 800 identifying the at least one other outstanding financial transaction.

In one or more embodiments, the reminder prompt 800 has a send user actuation target 803 that facilitates transmission, by the communication device (108), of at least one reminder communication that the outstanding financial transaction remains unresolved. In one or more embodiments, the reminder prompt 800 includes at least one user actuation target 801 allowing review of the reminder communication as well.

In one or more embodiments, the one or more processors (106) also present a consolidated payment report 804 on the user interface (104) after the payment deadline has passed, listing outstanding financial transaction debtors. Illustrating by example, in this illustrative example the consolidated payment report 804 indicates Eric and Jacob have yet to pay by the payment deadline, which is August twenty-fifth. Thus, as shown in FIG. 8, in one or more embodiments the notification identifies a quantity of electronic financial transaction debtors associated with the outstanding financial transaction who have outstanding electronic financial transaction debts due.

Additionally, as shown in FIGS. 6 and 7 above, the one or more processors (106) can present a notification identifying the electronic payment transaction confirmation as being associated with the outstanding financial transaction. In one or more embodiments, the notification specifies which financial transaction of multiple outstanding financial transactions the electronic payment transaction confirmation is associated with, providing clarity and aiding in financial management.

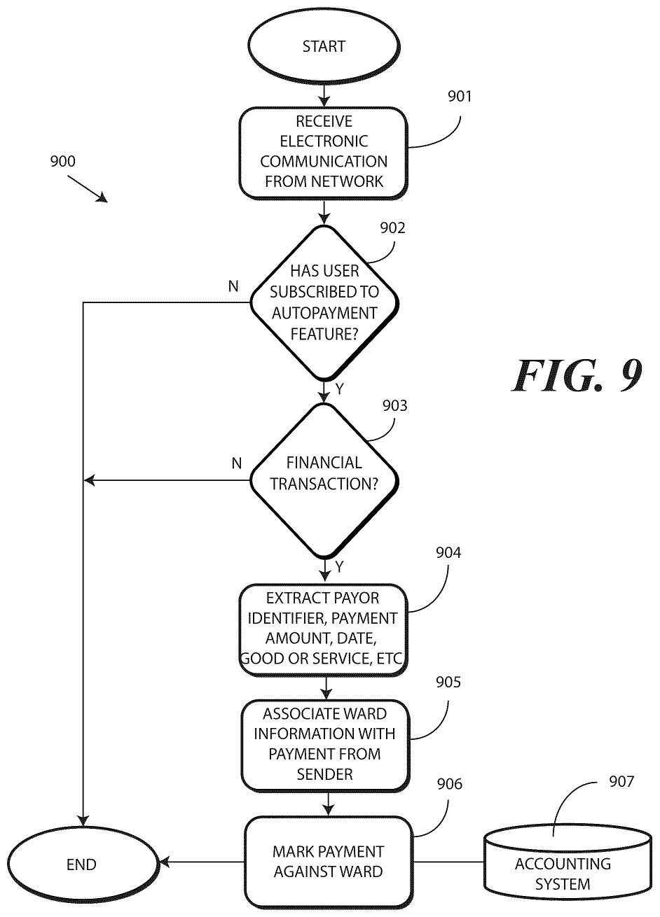

Turning now to FIG. 9, illustrated therein is another explanatory method 900 in accordance with one or more embodiments of the disclosure. Step 901 comprises receiving, by a communication device, an electronic communication. Decision 902 determines whether the user has opted into an automatic reminder prompt presentation feature of an application operating on the one or more processors. Recall from above that in one or more embodiments presentation of the reminder prompt occurs only when user settings of the electronic device opt in to an automatic reminder prompt presentation feature of an application operating on the one or more processors.

Decision 903 determines whether the electronic communication received at step 901 comprises an electronic payment transaction confirmation from an electronic payment transaction sender. Where it does, the method 900 moves to step 904. Otherwise, the method 900 ends.

Step 904 determines, by one or more processors operable with the communication device, that the electronic payment transaction confirmation is associated with an outstanding financial transaction having a payment due date that is associated with the electronic payment transaction sender. In one or more embodiments, step 904 involves extracting information from an electronic payment transaction confirmation using one or more processors operable with the communication device.

In one or more embodiments, this process begins by analyzing the electronic communication to identify transaction details. The system can employ Optical Character Recognition (OCR) technology to scan and interpret text within the confirmation, accurately identifying elements such as the electronic payment transaction sender, payment amount, and payment date. OCR technology handles various formats and fonts, ensuring precision in data extraction.

In addition to OCR, step 904 may parse structured data formats like JSON or XML embedded within the transaction confirmation. This approach leverages predefined data structures to directly access information, providing a reliable and efficient means of extraction. By utilizing structured data, the system quickly locates and retrieves necessary details without complex text analysis.

Machine learning algorithms further enhance the extraction process by analyzing patterns and context within the transaction confirmation at step 904. These algorithms adapt to variations in transaction formats, improving accuracy over time through continuous learning. This method provides flexibility and robustness, particularly in environments with diverse transaction confirmation styles. By employing these techniques, the system efficiently extracts comprehensive transaction information, facilitating accurate financial management and oversight.

Thus, in one or more embodiments step 904 extracts, by the one or more processors, a payment amount defined by the electronic payment transaction confirmation and the electronic payment transaction sender from the electronic payment transaction confirmation and an amount due from the outstanding financial transaction. Step 905 associates the electronic payment transaction confirmation sender with a particular outstanding electronic financial transaction. In one or more embodiments, step 905 comprises presenting, by the one or more processors on a user interface, a notification identifying the electronic payment transaction confirmation as being associated with the outstanding financial transaction. Step 906 then comprises interfacing, with the one or more processors, an accounting database 907 and recording the electronic payment transaction defined by the electronic payment transaction confirmation against the outstanding financial transaction.

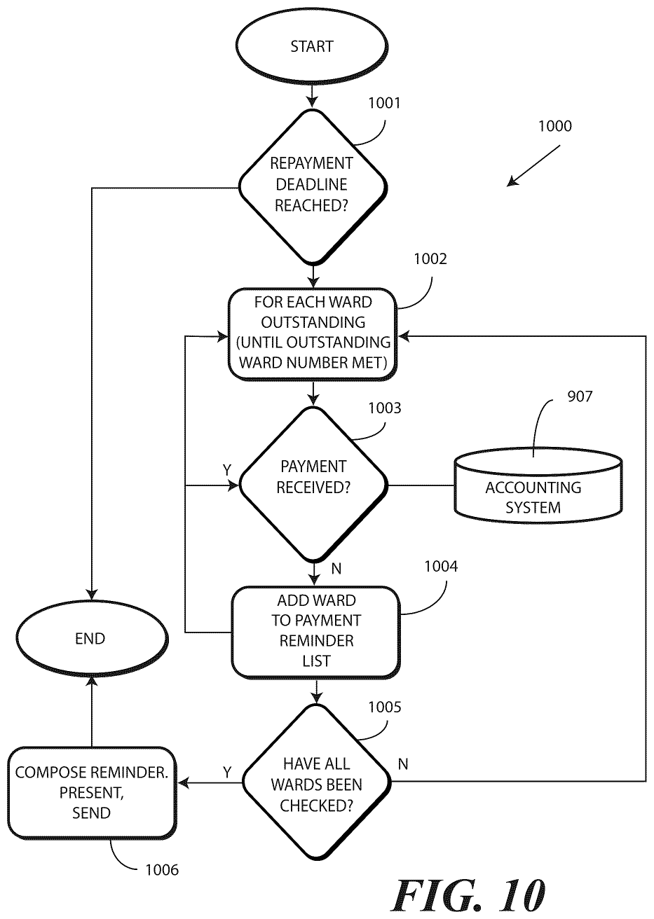

The method 900 of FIG. 9 handles incoming electronic communications with, for example, screenshots of electronic financial transaction confirmations. Turning now to FIG. 10, illustrated therein is a method 1000 for automatically handling overdue payments.

Decision 1001 determines, by the one or more processors, whether a payment due date is passed. Step 1002 determines at least one outstanding financial transaction debtor having an outstanding financial transaction debt associated with the outstanding financial transaction. This process can repeat for multiple outstanding financial transaction debtors.

Decision 1003 determines whether payments have been received, optionally by interfacing with the accounting database 907. Step 1004 adds the outstanding financial transaction debtor to a list to receive a reminder communication. Decision 1005 determines whether all outstanding financial transaction debtors have been checked.

Step 1006 presents a reminder prompt identifying the outstanding financial transaction debt and the at least one outstanding financial transaction debtor. In one or more embodiments, the reminder prompt facilitates transmission, by the communication device, of at least one reminder communication to an electronic device of the at least one outstanding financial transaction debtor. In one or more embodiments, step 1006 sends the at least one reminder communication to an electronic device of the at least one outstanding financial transaction debtor.

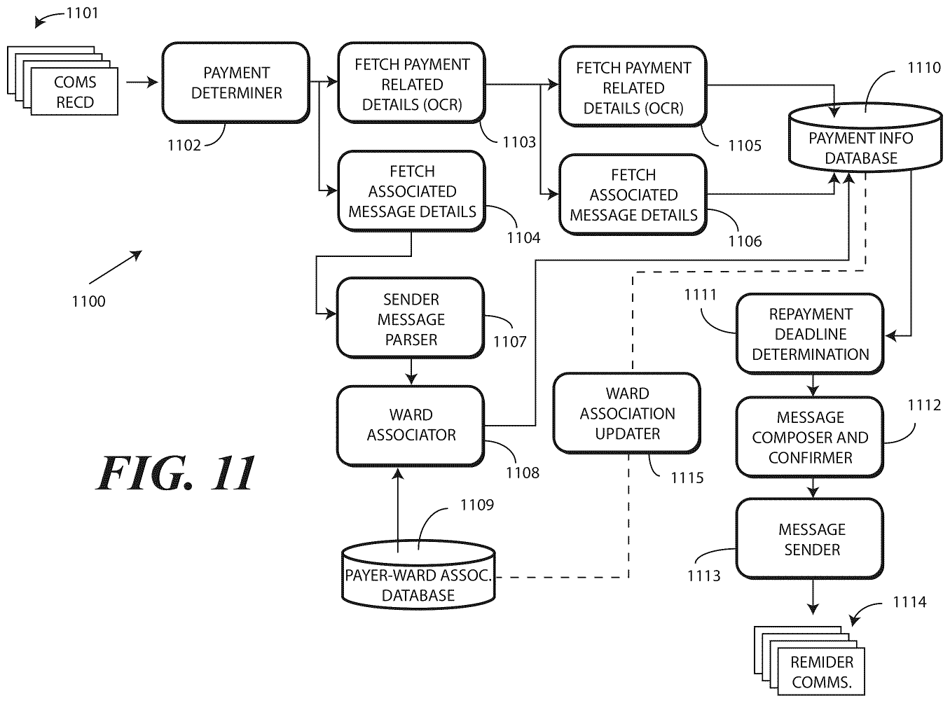

Turning now to FIG. 11, illustrated therein is one explanatory system 1100 that serves as one illustrative central framework for managing electronic payment transactions and associated communications. The system 1100 integrates various components to facilitate the extraction, processing, and management of payment-related data. The system 1100 ensures seamless interaction between components, enabling efficient financial transaction oversight.

The received communications 1101 component functions as the initial entry point for incoming messages. This component captures electronic communications, including text-based and visual-based messages, that may contain financial transaction details. The received communications 1101 component interfaces with the payment determiner 1102 to assess the relevance of each communication to financial transactions.

The payment determiner 1102 analyzes incoming communications to identify those related to payment transactions. By employing algorithms and pattern recognition techniques, the payment determiner 1102 discerns whether a communication contains transaction confirmations. This component interacts with the payment details fetcher 1103 to extract pertinent transaction information.

The payment details fetcher 1103 retrieves specific transaction details from identified communications. This component utilizes Optical Character Recognition (OCR) and data parsing methods to extract information such as transaction amounts, dates, and sender details. The payment details fetcher 1103 collaborates with the message details fetcher 1104 to ensure comprehensive data extraction.

The message details fetcher 1104 complements the payment details fetcher 1103 by extracting additional contextual information from communications. This component focuses on identifying sender information, communication timestamps, and other relevant metadata. The message details fetcher 1104 works in conjunction with the related payment details fetcher 1105 to correlate extracted data with existing records.

The related payment details fetcher 1105 cross-references extracted transaction details with stored financial records. This component ensures that each transaction is accurately associated with corresponding outstanding financial obligations. The related payment details fetcher 1105 interacts with the associated messages details fetcher 1106 to maintain data integrity.

The associated messages details fetcher 1106 identifies and retrieves related communications that may provide additional context for transactions. This component ensures that all relevant messages are considered when processing financial transactions. The associated messages details fetcher 1106 collaborates with the sender message parser 1107 to parse sender-specific information.

The sender message parser 1107 focuses on extracting and interpreting sender-specific data from communications. This component identifies payer information and correlates the payer information with existing records. The sender message parser 1107 interfaces with the ward associator 1108 to establish connections between payers and service receivers.

The ward associator 1108 establishes associations between payers and service receivers, particularly in scenarios where different users are involved, such as parents paying for children's services. This component ensures accurate mapping of financial transactions to the correct accounts. The ward associator 1108 interacts with the Payor/ward association database 1109 to store these associations.

The Payor/ward association database 1109 maintains records of payer and ward associations. This database serves as a reference for verifying and updating transaction associations. The Payor/ward association database 1109 collaborates with the payment information database 1110 to ensure consistency in financial records.

The payment information database 1110 stores detailed records of financial transactions, including amounts, dates, and associated parties. This database supports the system's ability to track and manage outstanding financial obligations. The payment information database 1110 interfaces with the repayment deadline determiner 1111 to monitor payment deadlines.

The repayment deadline determiner 1111 calculates and tracks payment deadlines for outstanding financial transactions. This component ensures timely notifications and reminders for overdue payments. The repayment deadline determiner 1111 collaborates with the message composer and confirmer 1112 to generate communication prompts.

The message composer and confirmer 1112 generates and confirms messages related to financial transactions. This component creates reminders and notifications for outstanding payments, ensuring clear communication with debtors. The message composer and confirmer 1112 interacts with the message sender 1113 to facilitate message transmission.

The message sender 1113 handles the transmission of messages generated by the message composer and confirmer 1112. This component ensures that reminders and notifications reach the intended recipients. The message sender 1113 collaborates with the reminder communications 1114 to manage communication delivery.

The reminder communications 1114 component manages the scheduling and delivery of reminder messages. This component ensures that reminders are sent at appropriate times, based on user preferences and payment deadlines. The reminder communications 1114 interacts with the ward association updater 1115 to update records as needed.

The ward association updater 1115 updates records in the Payor/ward association database 1109 based on new information or changes in payer-ward relationships. This component ensures that associations remain accurate and up to date. The ward association updater 1115 collaborates with the system 1100 to maintain data integrity across all components.

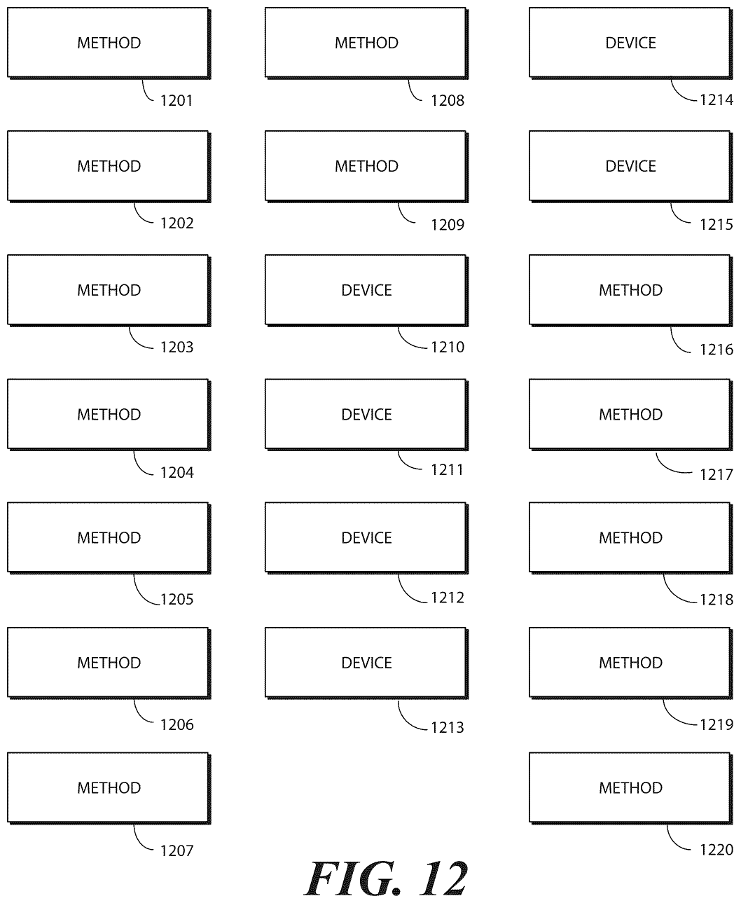

Turning now to FIG. 12, illustrated therein are various embodiments of the disclosure. The embodiments of FIG. 12 are shown as labeled boxes in FIG. 12 due to the fact that the individual components of these embodiments have been illustrated in detail in FIGS. 1-11, which precede FIG. 12. Accordingly, since these items have previously been illustrated and described, their repeated illustration is no longer essential for a proper understanding of these embodiments. Thus, the embodiments are shown as labeled boxes.

At 1201, a method in an electronic device comprises receiving, by a communication device, an electronic communication comprising an electronic payment transaction confirmation from an electronic payment transaction sender. At 1201, the method comprises determining, by one or more processors operable with the communication device, that the electronic payment transaction confirmation is associated with an outstanding financial transaction associated with the electronic payment transaction sender. At 1201, the method comprises extracting, by the one or more processors, a payment amount defined by the electronic payment transaction confirmation and the electronic payment transaction sender from the electronic payment transaction confirmation and an amount due from the outstanding financial transaction. At 1201, the method comprises presenting, by the one or more processors on a user interface, a notification identifying the electronic payment transaction confirmation as being associated with the outstanding financial transaction.

At 1202, the method of 1201 further comprises determining at least one other outstanding financial transaction of the plurality outstanding financial transactions is beyond a payment due date for the at least one other financial transaction. At 1202, the method comprises generating, by the one or more processors, at least one reminder communication that the at least one outstanding financial transaction remains outstanding.

At 1203, the method of 1202 further comprises presenting, by the one or more processors, a reminder prompt identifying the at least one other outstanding financial transaction facilitating transmission, by the communication device, of the at least one reminder communication. At 1204, the plurality of outstanding financial transactions of 1203 is associated with a single financial transaction event.

At 1205, the payment due date of 1203 is defined by user input received by the user interface for the at least one other outstanding financial transaction. At 1206, the presenting the reminder prompt of 1203 occurs only when user settings of the electronic device opt in to an automatic reminder prompt presentation feature of an application operating on the one or more processors.

At 1207, the method of 1203 further comprises interfacing, with the one or more processors, an accounting database and recording the electronic payment transaction defined by the electronic payment transaction confirmation against the outstanding financial transaction. At 1208, the reminder prompt of 1203 comprises at least one user actuation target allowing the at least one reminder communication to be reviewed. At 1209, the reminder prompt of 1208 comprises at least one user actuation target that, when actuated, causes the communication device to send the at least one reminder communication.

At 1210, an electronic device comprises a user interface, a communication device, and one or more processors operable with the user interface and the communication device. At 1210, the one or more processors are configured to, in response to the communication device receiving an electronic communication defining an electronic payment transaction confirmation, associate an electronic payment transaction defined by the electronic payment transaction confirmation with an outstanding financial transaction of a plurality of outstanding financial transactions stored in a memory of the electronic device and, when a payment deadline associated with the plurality of financial transactions has passed, determine at least one other outstanding financial transaction of the plurality outstanding financial transactions is beyond the payment deadline and present, on the user interface, a reminder prompt identifying the at least one other outstanding financial transaction.

At 1211, the reminder prompt of 1210 facilitates transmission, by the communication device, of at least one reminder communication that the at least one outstanding financial transaction remains outstanding. At 1212, the prompt of 1211 comprises at least one user actuation target allowing review of the at least one reminder communication.

At 1213, the one or more processors of 1212 are further configured to present a consolidated payment report on the user interface after the payment deadline has passed with the consolidated payment report listing outstanding financial transaction debtors. At 1214, the one or more processors of 1210 are further configured to present, on the user interface, a notification identifying the electronic payment transaction confirmation as being associated with the outstanding financial transaction. At 1215, the outstanding financial transaction of 1214 is one of multiple outstanding financial transactions associated with an outstanding financial transaction debtor. At 1215, the notification identifies which financial transaction of the multiple outstanding financial transactions the electronic payment transaction confirmation is associated.

At 1216, a method in an electronic device comprises receiving, by a communication device, an electronic communication comprising an electronic payment transaction confirmation from an electronic payment transaction sender. At 1216, the method comprises determining, by one or more processors operable with the communication device, that the electronic payment transaction confirmation is associated with an outstanding financial transaction having a payment due date that is associated with the electronic payment transaction sender. At 1216, the method comprises also determining, by the one or more processors after the payment due date is passed, at least one outstanding financial transaction debtor having an outstanding financial transaction debt associated with the outstanding financial transaction.

At 1216, the method comprises presenting, by the one or more processors, a reminder prompt identifying the outstanding financial transaction debt and the at least one outstanding financial transaction debtor. At 1217, the reminder prompt of 1216 facilitates transmission, by the communication device, of at least one reminder communication to an electronic device of the at least one outstanding financial transaction debtor.

At 1218, the method of 1217 further comprises extracting, by the one or more processors, a payment amount defined by the electronic payment transaction confirmation and the electronic payment transaction sender from the electronic payment transaction confirmation and an amount due from the outstanding financial transaction. At 1218, the method comprises presenting, by the one or more processors on a user interface, a notification identifying the electronic payment transaction confirmation as being associated with the outstanding financial transaction. At 1218, the method comprises interfacing, with the one or more processors, an accounting database and recording the electronic payment transaction defined by the electronic payment transaction confirmation against the outstanding financial transaction.

At 1219, the user interface of 1218 presents two electronic payment transaction confirmations from the electronic payment transaction sender the one or more processors cause the user interface to present two notifications identifying the two electronic payment transaction confirmations as being associated with two different outstanding financial transactions. At 1220, the notification of 1218 identifies a quantity of electronic financial transaction debtors associated with the outstanding financial transaction who have outstanding electronic financial transaction debts due.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, by a communication device, an electronic communication comprising an electronic payment transaction confirmation from an electronic payment transaction sender;
determining, by one or more processors operable with the communication device, that the electronic payment transaction confirmation is associated with an outstanding financial transaction associated with the electronic payment transaction sender;
extracting, by the one or more processors, a payment amount defined by the electronic payment transaction confirmation and the electronic payment transaction sender from the electronic payment transaction confirmation and an amount due from the outstanding financial transaction; and
presenting, by the one or more processors on a user interface, a notification identifying the electronic payment transaction confirmation as being associated with the outstanding financial transaction.

2. The method of claim 1, wherein the outstanding financial transaction is one of a plurality of outstanding financial transactions, further comprising:
determining at least one other outstanding financial transaction of the plurality outstanding financial transactions is beyond a payment due date for the at least one other financial transaction; and
generating, by the one or more processors, at least one reminder communication that the at least one other outstanding financial transaction remains outstanding.

3. The method of claim 2, further comprising presenting, by the one or more processors, a reminder prompt identifying the at least one other outstanding financial transaction facilitating transmission, by the communication device, of the at least one reminder communication.

4. The method of claim 3, wherein the plurality of outstanding financial transactions is associated with a single financial transaction event.

5. The method of claim 3, wherein the payment due date is defined by user input received by the user interface for the at least one other outstanding financial transaction.

6. The method of claim 3, wherein the presenting the reminder prompt occurs only when user settings of the electronic device opt in to an automatic reminder prompt presentation feature of an application operating on the one or more processors.

7. The method of claim 3, further comprising interfacing, with the one or more processors, an accounting database and recording an electronic payment transaction defined by the electronic payment transaction confirmation against the outstanding financial transaction.

8. The method of claim 3, wherein the reminder prompt comprises at least one user actuation target allowing the at least one reminder communication to be reviewed.

9. The method of claim 8, wherein the reminder prompt comprises at least one user actuation target that, when actuated, causes the communication device to send the at least one reminder communication.

10. An electronic device, comprising:
a user interface;
a communication device; and
one or more processors operable with the user interface and the communication device;
wherein the one or more processors are configured to, in response to the communication device receiving an electronic communication defining an electronic payment transaction confirmation, associate an electronic payment transaction defined by the electronic payment transaction confirmation with an outstanding financial transaction of a plurality of outstanding financial transactions stored in a memory of the electronic device and, when a payment deadline associated with the plurality of outstanding financial transactions has passed, determine at least one other outstanding financial transaction of the plurality outstanding financial transactions is beyond the payment deadline and present, on the user interface, a reminder prompt identifying the at least one other outstanding financial transaction.

11. The electronic device of claim 10, wherein the reminder prompt facilitates transmission, by the communication device, of at least one reminder communication that the at least one other outstanding financial transaction remains outstanding.

12. The electronic device of claim 11, wherein the prompt comprises at least one user actuation target allowing review of the at least one reminder communication.

13. The electronic device of claim 12, wherein the one or more processors are further configured to present a consolidated payment report on the user interface after the payment deadline has passed with the consolidated payment report listing outstanding financial transaction debtors.

14. The electronic device of claim 10, wherein the one or more processors are further configured to present, on the user interface, a notification identifying the electronic payment transaction confirmation as being associated with the outstanding financial transaction.

15. The electronic device of claim 14, wherein the outstanding financial transaction is one of multiple outstanding financial transactions associated with an outstanding financial transaction debtor, wherein the notification identifies which financial transaction of the multiple outstanding financial transactions the electronic payment transaction confirmation is associated.

16. A method in an electronic device, the method comprising:
receiving, by a communication device, an electronic communication comprising an electronic payment transaction confirmation from an electronic payment transaction sender;
determining, by one or more processors operable with the communication device, that the electronic payment transaction confirmation is associated with an outstanding financial transaction having a payment due date that is associated with the electronic payment transaction sender;
also determining, by the one or more processors after the payment due date is passed, at least one outstanding financial transaction debtor having an outstanding financial transaction debt associated with the outstanding financial transaction; and
presenting, by the one or more processors, a reminder prompt identifying the outstanding financial transaction debt and the at least one outstanding financial transaction debtor.

17. The method of claim 16, wherein the reminder prompt facilitates transmission, by the communication device, of at least one reminder communication to an electronic device of the at least one outstanding financial transaction debtor.

18. The method of claim 17, further comprising:
extracting, by the one or more processors, a payment amount defined by the electronic payment transaction confirmation and the electronic payment transaction sender from the electronic payment transaction confirmation and an amount due from the outstanding financial transaction;
presenting, by the one or more processors on a user interface, a notification identifying the electronic payment transaction confirmation as being associated with the outstanding financial transaction; and
interfacing, with the one or more processors, an accounting database and recording an electronic payment transaction defined by the electronic payment transaction confirmation against the outstanding financial transaction.

19. The method of claim 18, wherein when the user interface presents two electronic payment transaction confirmations from the electronic payment transaction sender the one or more processors cause the user interface to present two notifications identifying the two electronic payment transaction confirmations as being associated with two different outstanding financial transactions.

20. The method of claim 18, wherein the notification identifies a quantity of electronic financial transaction debtors associated with the outstanding financial transaction who have outstanding electronic financial transaction debts due.
